(19) United States
(12) Patent Application Publication
(10) Pub. No.: US 2026/0214190 A1
(43) Pub. Date: Jul. 23, 2026

(54) ROBOTIC SURFACE MODIFICATION SYSTEMS AND METHODS

(71) Applicant: 3M INNOVATIVE PROPERTIES COMPANY, St. Paul, MN (US)

(72) Inventors: Rudy M. Lawler, Sioux Falls, SD (US); Sarah A. Medley, St. Paul, MN (US); Robert A. Knutson, Lakeville, MN (US); Jonathan B. Arthur, Hudson, WI (US); Simron Thapa, Cottage Grove, MN (US); Alireza Ghaderi, Woodbury, MN (US)

(21) Appl. No.: 19/143,022

(22) PCT Filed: Dec. 19, 2023
(86) PCT No.: PCT/IB2023/062953

§ 371 Date: Jun. 25, 2025

Related U.S. Application Data
(60) Provisional application No. 63/477,230, filed on Dec. 27, 2022.
(60) Provisional application No. 63/584,507, filed on Sep. 22, 2023.

(51) Int. Cl. H04N 9/31; B25J 19/02; G01B 11/25; G01N 21/88; G01N 21/95

(52) U.S. Cl. CPC H04N 9/3185; B25J 19/023; G01B 11/25; G01N 21/8806; G01N 21/9515; H04N 9/3176; H04N 9/3182

(57) ABSTRACT

An imaging system for a reflective surface is presented that includes a light source. The system also includes an imaging device positioned to capture images of the reflective surface. The system also includes a static structured light pattern configured to adjust from a first curved configuration to a second curved configuration. The first curved configuration comprises a different shape than the second curved configuration. The light source is positioned such that light shines through the static structured light pattern and is reflected from the reflective surface into a field of view of the imaging device.

### BACKGROUND

Surface modification on specular surfaces presents challenges for imaging, surface trajectory design, and evaluation pre and post-modification.

### SUMMARY

An imaging system for a reflective surface is presented that includes a light source. The system also includes an imaging device positioned to capture images of the reflective surface. The system also includes a static structured light pattern configured to adjust from a first curved configuration to a second curved configuration. The first curved configuration comprises a different shape than the second curved configuration. The light source is positioned such that light shines through the static structured light pattern and is reflected from the reflective surface into a field of view of the imaging device.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a schematic of a robotic surface modification system in which embodiments of the present invention are useful.

FIG. 2 illustrates a method of surface modification in accordance with embodiments herein.

FIGS. 3A-3D illustrate images captured by an image capturing system as described in embodiments herein.

FIGS. 4A and 4B illustrate a schematic of a surface modification imaging system in operation.

FIGS. 5A-5C illustrate a surface modification imaging system in accordance with embodiments herein.

FIG. 6 illustrate different structured light patterns that can be placed over a light source to provide structured illumination for the imaging system.

FIGS. 7A-1 to 7F illustrate images of reflected gridded light on surfaces generated using systems and methods herein.

FIGS. 8A and 8B illustrate a schematic of a surface imaging system in accordance with embodiments herein.

FIGS. 9A-9B illustrate a schematic of an outward facing surface imaging system in accordance with embodiments herein.

FIGS. 10A-10B illustrate a schematic of a binocular normal facing surface imaging system in accordance with embodiments herein.

FIG. 11 illustrates a schematic of a flat dome light surface imaging system in accordance with embodiments herein.

FIG. 12 illustrates a surface modification system in accordance with embodiments herein.

FIG. 13 illustrates a process for setting up a robotic surface modification unit.

FIG. 14 illustrates an operational sequence for a surface modification operation by a robotic repair unit.

FIG. 15 illustrates an end-of-arm tool configuration for a robotic surface modification unit in accordance with embodiments herein

FIG. 16 illustrates an operational sequence for a surface modification operation by a robotic repair unit in some embodiments herein

FIG. 17 is a surface modification system architecture.

FIGS. 18-19 show examples of mobile devices that can be used in the embodiments shown in previous Figures.

FIG. 20 is a block diagram of a computing environment that can be used in embodiments shown in previous Figures.

### DETAILED DESCRIPTION

Recent advancements in imaging technology and computational systems has made feasible the process of clear coat inspection at production speeds. In particular, stereo deflectometry has recently been shown to be capable of providing images and locations of paint and clear coat defects at appropriate resolution with spatial information (providing coordinate location information and defect classification) to allow to allow subsequent accurate relocation and automated spot repair.

However, particularly in the automotive industry, many of the surfaces that contain defects are not flat. And the vehicle may move between an initial inspection location and a repair location. It is important to verify the exact position of the vehicle so that an exact defect location is known. It may also be important to recharacterize, or confirm initial characterization, of the defect closer to the time a repair happens.

Systems and methods herein provide for imaging of a surface using a compact end-of arm system on a robotic surface modifying unit. In some embodiments, the imaging system is mounted near a robotic surface modifying tool on the robotic unit. Having a system that can be mounted on an end of the same robotic arm as a surface modifying tool (as opposed to on a separate robotic unit) provides significant advantages including in-situ measurement during a surface modification operation and reduced error in movement transition between the tool and the imaging system. However, the imaging system has to be compact enough such that a robotic arm can maneuver a surface modifying tool into position for a surface modifying operation. The images may be processed in-situ to generate a surface characterization, a surface modification trajectory, etc. The same (or a different) imaging system may be used post-surface modification operation to recharacterize the surface to understand whether the surface modification is sufficient. For example, a vehicle may have a clearcoat defect in an area on a surface that, post-repair (e.g. sanding and polishing), has significant haze, which may be significant enough to be considered unacceptable aesthetically.

However, while systems and methods are described herein that envision an end-of-arm imaging system, it is expressly contemplated that, in some embodiments, the imaging system may be on a separate robotic unit. In some embodiments, an end-of-arm imaging system may be mounted to the same robotic arm as a surface modification tool, but in a separate mount position.

As used herein, the term “vehicle” is intended to cover a broad range of mobile structures that receive at least one coat of paint and/or clear coat during manufacturing. While many examples herein concern automobiles, it is expressly contemplated that methods and systems described herein are also applicable to trucks, trains, boats (with or without motors), airplanes, helicopters, motorcycles, etc.

The term “paint” is used herein to refer broadly to any of the various layers of e-coat, filler, primer, paint, clear coat, etc. of the vehicle that have been applied in the finishing process. Additionally, the term “paint repair” involves locating and repairing any visual artifacts (defects) on or within any of the paint layers. In some embodiments, systems and methods described herein use clear coat as the target paint repair layer. However, the systems and methods presented apply to any particular paint layer (e-coat, filler, primer, paint, clear coat, etc.) with little to no modification.

As used herein, the term “defect” refers to an area on a worksurface that interrupts the visual aesthetic. For example, many vehicles have specular, or reflective, surfaces that may appear shiny or metallic after painting is completed. A “defect” can include debris trapped within one or more of the various paint layers on the work surface. Defects can also include smudges in the paint, excess paint including smears or dripping, inconsistent orange peel, as well as dents. As used herein, “defect” includes both aesthetic interruptions occurring during paint application or during a repair process. A surface may have some haze on a surface, for example, which is made worse during a defect repair operation. Or, a surface may have no significant haze in an area containing a defect (e.g. trapped debris, scratch) prior to a repair operation, but a level of unacceptable haze post-repair of said defect.

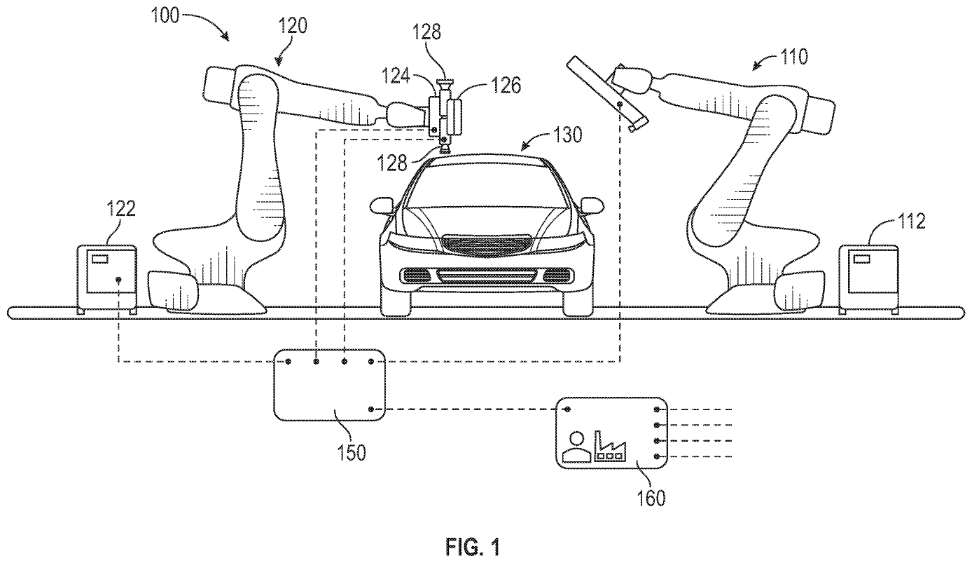

FIG. 1 is a schematic of a robotic paint repair system in which embodiments of the present invention are useful. System 100 generally includes two units, a visual inspection system 110 and a defect repair system 120. Both systems may be controlled by a motion controller 112, 122, respectively, which may receive instructions from one or more application controllers 150. The application controller may receive input, or provide output, to a user interface 160. Repair unit 120 includes a force control unit 124 that can be aligned with an end-effector 126. As illustrated in FIG. 1, end effector 126 includes two tools 128, as further described in co-pending U.S. Provisional Patent Application 62/940950 filed on Nov. 27, 2019. It is also noted that end effector 126 includes an imaging system 127 positioned such that rotation, or linear movement of end effector 126 can allow for switching between one of tools 128 and imaging system 127. However, other arrangements are also expressly contemplated. For example, while FIG. 1 illustrates a repair unit 120 operating simultaneously with imaging system 110, it is expressly contemplated that repair unit 120 operates at least at a time delay from imaging system 110, such that at least some movement of repair unit 120 is informed by data collected from repair unit 110.

The first of the two main challenges, inspection of vehicle 130 by inspection unit 110, is interesting due to the nature of the underlying problem domain. In general, the surface of interest is very large in comparison to the defects themselves, with the difference being multiple orders of magnitude. This results in trade-offs between field of view and resolution when it comes to sensor selection as well as lens selection, crucial for creating a required angular field of view. Additionally, each paint layer of the finishing process (e-coat, primer, paint, clear coat, etc.) differs in its visual appearance with specularity being particular noteworthy. Highly specular surfaces (i.e., high-gloss or highly reflective surfaces) pose unique imaging challenges. These issues together make inspection difficult. Recent progress in the last few years has been made in this area making use of increasing computational resources, resulting in the availability of several commercial solutions. The presence of a sufficiently capable inspection system 110 is important for identifying defects for repair by repair unit 120.

The current state of the art in vehicle paint repair is to use fine abrasive and/or polish systems to manually sand/polish out the defects, with or without the aid of a power tool, while maintaining the desirable finish (e.g., matching specularity in the clear coat). An expert human executing such a repair leverages many hours of training while simultaneously utilizing their senses to monitor the progress of the repair and make changes accordingly. Such sophisticated behavior is hard to capture in a robotic solution with limited sensing.

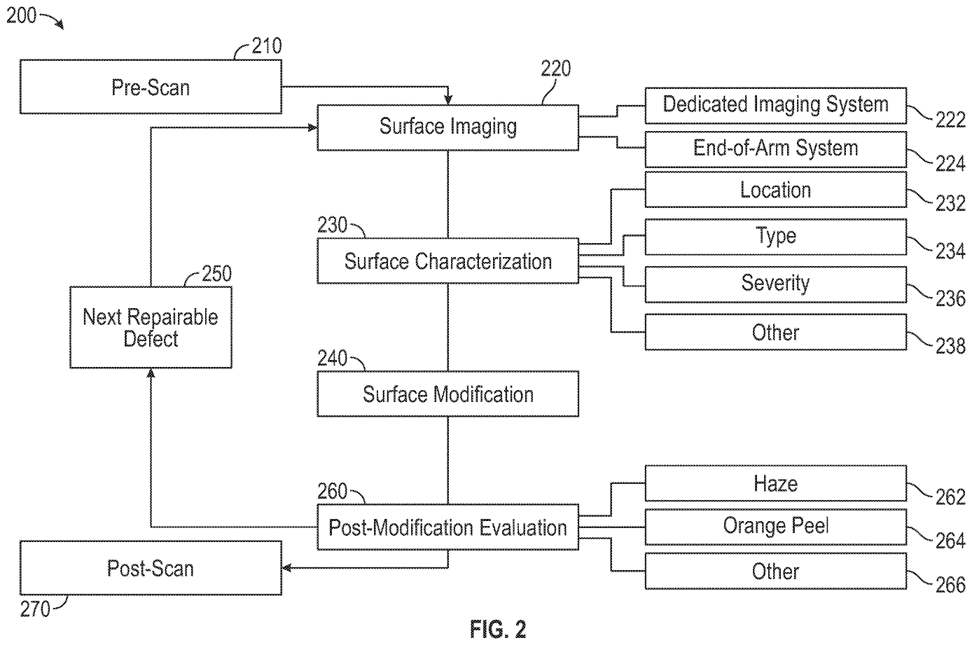

It is expressly noted that, throughout the present description, the example of surface modification of a vehicle surface to remove paint-related defects from a surface is presented as one potential use case. However, other surface modifications are expressly contemplated, such as other abrasive operations (sanding, grinding), other additive processes (e.g. additive manufacturing, adhesive deposition, etc.), or subtractive processes (material removal, cutting, etc.) FIG. 2 illustrates a method of surface modification in accordance with an embodiment of the present invention. While method 200 is described in the context for surface defect repair on a vehicle, it is expressly contemplated that other use cases may also benefit from systems and methods herein.

In block 210, an initial scan of the surface to be modified is done. This initial scan may be done at a first location, for example in the vehicle repair context, at an inspection station.

As illustrated in FIG. 2, the steps of imaging 220, surface characterization 230, surface modification 240, and post-modification evaluation, are repeated for a number of defects on the surface. In the vehicle context, a surface may have multiple discrete defects needing repair on a surface. However, some detected defects during and the initial scan of block 210 may not need repair, or may not be repairable by an on-site repair unit. For the number of defects that can be repaired by a robotic repair unit, the steps 220, 230, 240, and 260 repeat until all defects are repaired to an acceptable level, or as allowed by production/timing constraints. An acceptable level may be determined, for example, by an industry accepted size, a manufacturer quality tolerance, or another standard such as visibility by the human eye, etc.

In block 270, a second scan of the entire surface may be completed, for example by the same imaging system as that of block 210, using the imaging system of blocks 220-260, or another imaging system.

In the paint defect repair context, the scan conducted in block 210 is often used to locate defects on a surface, not necessarily to characterize the defects in detail, or to select a surface modification sequence for addressing detected defects. The initial scan of block 210 may be used, for example to determine which defects detected need to be repaired, and can be repaired by an on-site robotic surface modification unit.

In block 220, local surface imaging is conducted. In the context of vehicle defect repair, a dedicated imaging system 222 may capture information about the surface at the point of the detected defect. Dedicated imaging system 222 may be an imaging system separate from a robotic surface modification unit, or may be part of an end of arm system 224 of a robotic surface modification unit.

In block 230, characterization of the image surface is done. Characterization may include confirming an exact location 232 on a surface needing modification. For example, defect location may be confirmed with a high degree of accuracy in three-dimensional space. Additionally, a surface modification sequence may be generated, for example based on a type of modification sequence 234 necessary. For example, a scratch is repaired by a robotic repair unit differently than a nib caused by trapped debris. Additionally, a crater is repaired in yet another manner. The surface modification sequence 234 may also be selected based on the severity 236 of the detected defect. For example, large piece of trapped debris may require additional pressure, longer contact time, or a different abrasive article, then a small piece of trapped debris. Other surface characterization considerations 238 may also be important, such as anticipated vehicle use, status of other layers of paint, etc. For example, an initial orange peel characterization may be done on the surface around a detected defect, to ensure that a selected surface modification sequence maintains, or blends into the orange peel around the surface.

In block 240, a surface modification operation is conducted. The surface modification 240 may be conducted based on the surface modification sequence selected in block 230, or based on other considerations. The surface modification 240 may be either an additive or subtractive modification based on a need of a work surface being modified. The surface modification 240 may include a trajectory that includes a path consisting of a series of waypoints, between each waypoint a surface modification tool travels at a speed, angle, and applied pressure.

In block 260, after a surface modification sequence is completed, a post modification evaluation may be done of the surface. It is expressly contemplated that post modification evaluation 260 may be done using the imaging system used in block 220, the imaging system used in block 210, or another imaging system. However, as described herein, an end-of-arm system 224 provides sufficient flexibility to allow for the same imaging system to be used in blocks 220 and 260, which may increase efficiency and accuracy in addressing a number of repairable defects on a surface. Post modification evaluation 260 may include evaluating and measuring the surface for a number of features, for example haze 262 introduced on a surface as a result of the surface modification, whether or not orange peel 264 has been disrupted, or other features 266, for example introduced scratch as, etc.

In block 250, the defect area is inspected to determine whether the repair is sufficient. If additional repair is needed, method 200 may receive new instructions, as indicated by arrow 260, and the method may repeat. Inspecting a defect repair may include capturing post-repair images 252, which may be presented to a repair operator or saved as needed. Inspecting may also include validating the repair, as indicated in block 254, which may include comparing pre-and post-repair images, detecting whether a defect will be visible/noticeable to the human eye, or another suitable validation technique. In some embodiments, captured images are analyzed by an operational system or quality assurance, tracking and process management.

Co-filed application 63/584,506, filed herewith, describes another image capture system for surface modification that can be used for a number of worksurfaces. Systems and methods described herein are particularly useful for worksurfaces with a significant amount of curvature.

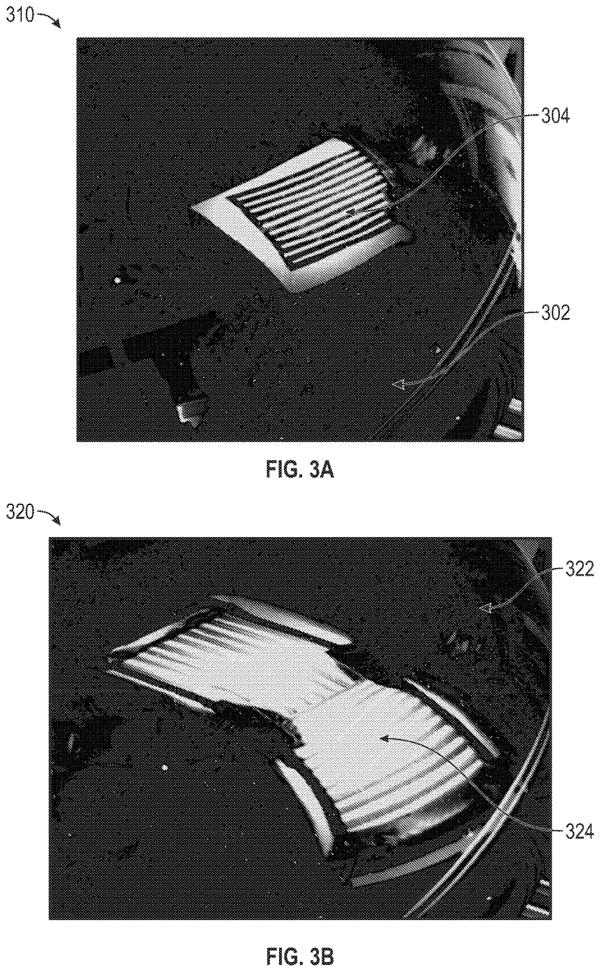

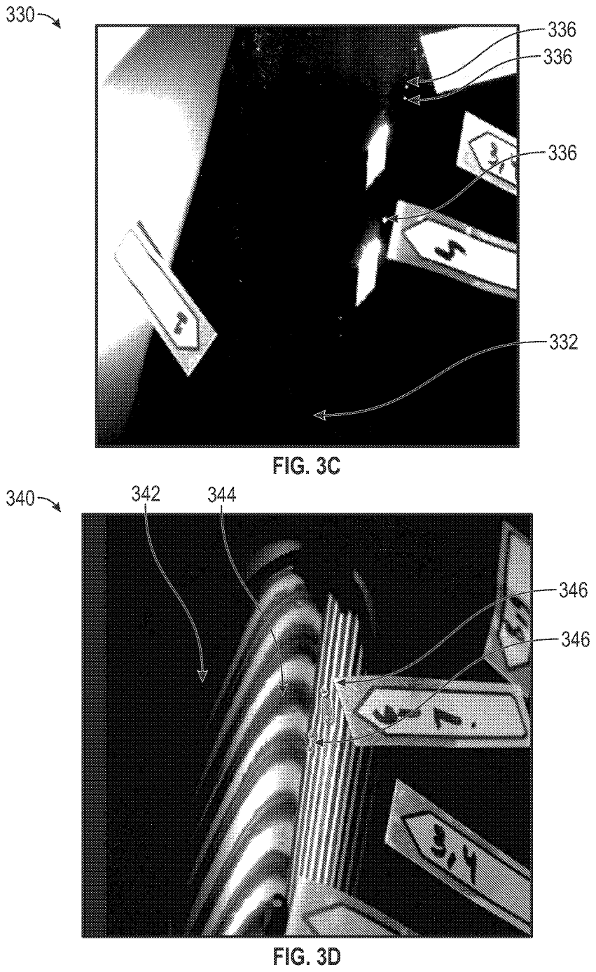

FIGS. 3A-3D illustrate images captured by an image capturing system as described in embodiments herein. As discussed herein, an image capturing system may be mounted on an end effector of a robotic repair unit. However, other locations are also possible in other embodiments.

FIG. 3A illustrates a structured light image 310 of a surface, the image captured with a flat static structured light. Surface 302 has curvature, resulting in a distorted light projection 304. In contrast, FIG. 3B illustrates an image 320 taken on the same curved surface 322, with a light projection 324 that follows the curvature of surface 320, resulting in less distortion.

Similarly, FIGS. 3C and 3D both illustrate images, 330 and 340 respectively, of a surface that has high curvature. FIG. 3C illustrates image 330, taken by a camera with a flat static structured light. The curvature of surface 332 is hard to determine, and defects 336 are harder to detect on the surface. FIG. 3D illustrates an image 340 of a surface 342. Because the structured light used by the system that captured image 340 is curved, it is much easier to see the curvature 344 of surface 342. Defects 346 are also more easily detected. Light collimation and more comprehensive diffusion management may be used to prevent defects from being washed out. Typically, defects are washed out when light is hitting at all angles. It is desired to capture a shadow effect (described herein) which assists in characterization.

Systems and methods herein provide light shaping diffusers and other optical elements to assist in the characterization of curved, specular surfaces.

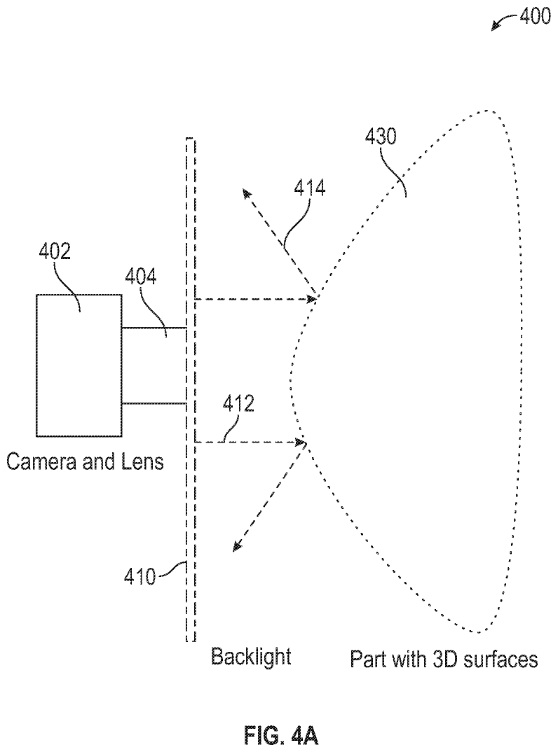

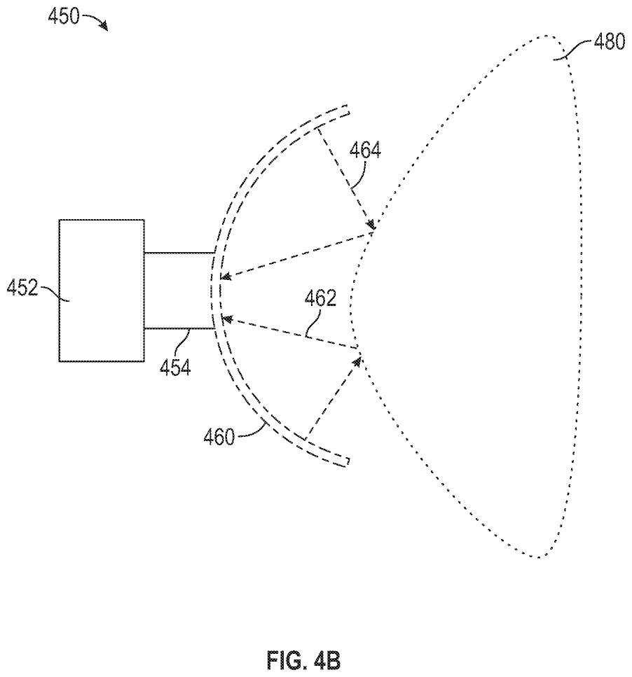

FIGS. 4A and 4B illustrate a schematic of a surface modification imaging system in operation. FIG. 4A illustrates a schematic 400 of noncurved collimated backlight 410 on a surface. The collimated backlight 410 receives light from the collimated backlight 410. Since backlight 410 is not curved, light 412 hits a surface and reflects off as illustrated by ray 414. As illustrated, at least some rays 414 are not received by camera 402 with lens 404. As seen in FIGS. 3A-3D, it is difficult to obtain clear images with camera 402, of surface 430, as illumination is poor and a static structured light pattern on collimated backlight 410 is distorted on surface 430. Using systems herein it is possible to align to surfaces with greater curvature and/or corners.

FIG. 4B illustrates a schematic 450 of a surface modification imaging system with a curved collimated light source 460. As illustrated, because backlight 460 has a radius of curvature that is similar to a radius of curvature of surface 480, light reflected from a light source 464 is reflected back, as illustrated by ray 462, such that camera 452 with lens 454 receives it.

In some embodiments herein, light 460 has a flexible backing, such that a radius of curvature can change as needed based on curvature of a surface 480. For example, if curvature of surface 480 was sharper, a radius of curvature of backlight 460 would be smaller. If curvature of surface 480 was gentler, radius of curvature of backlight 460 could be greater. Curvature of light source 460 may change based on a known or estimated topography of surface 480. For example, in an initial scanning step, e.g. pre-scan 210, an estimated topography may be received. However, in other embodiments, curvature may be estimated, or known exactly, from a computer aided design file that is accessible to controllers of the robotic system. Thus, when a controller programs movement of a robot tool that contains camera system 452 on an end of arm, when camera system 452 is moved into place, backlight 460 can be adjusted to have higher or lower curvature.

It is desired to align the light source to the normal of the surface being imaged. Described herein are systems where a light source has a similar curvature to a surface being imaged. Herein, being ‘similar’ may include being within a 10° tolerance range, in some embodiments. However, it is expressly contemplated that a ‘similar’ curvature may also include any curvature similar enough to provide an image from the surface that can be evaluated for defect characterization.

FIGS. 4A-4B has been described as having a light source 460 that is a collimated backlight. However it is expressly contemplated that other light sources are feasible, in other embodiments. As illustrated in the comparison between FIGS. 4A and 4B, as well as between 4C and 4D, adding a variety of positions and/or angles that the light comes from enables more angles of specular reflection that trace back to the camera.

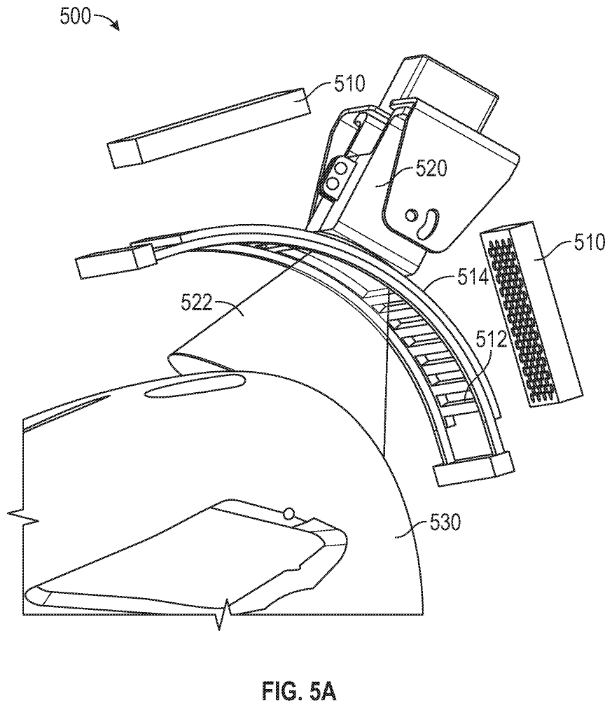

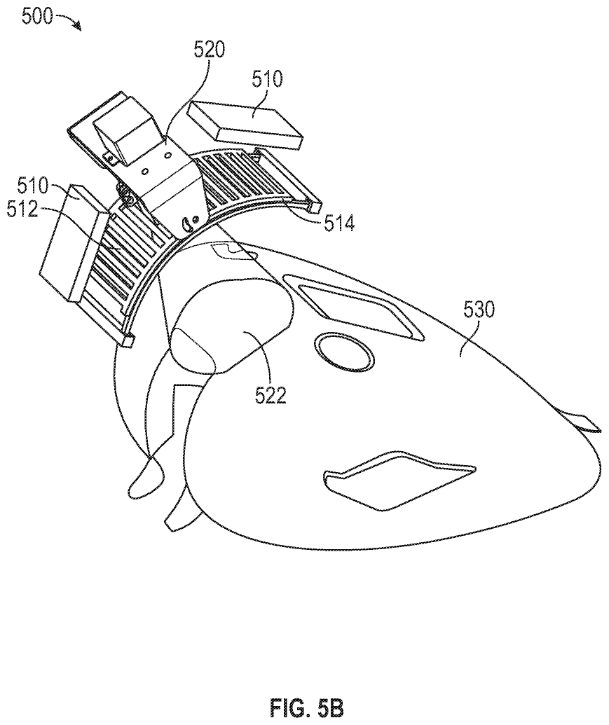

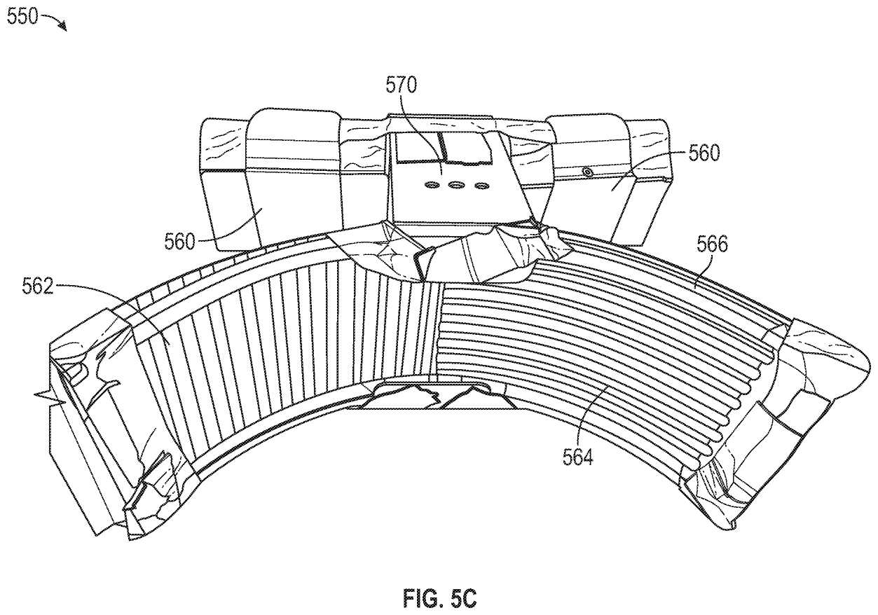

FIGS. 5A-5C illustrate a surface modification imaging system in accordance with embodiments herein. Camera 520 is illustrated with a mount that couples to an end of arm system of a robotic surface modification unit (not shown). Light sources 510 are illustrated as separate from a structured light pattern 512, and angled with respect to camera 520. However, it is expressly contemplated that, in some embodiments, light sources 510 may be part of a unit with structured light pattern 512. For example, light sources 510 may be curved, and pattern 512 may be placed over, or otherwise built into light sources 510. It is expressly contemplated that light sources 510 may also be coupled to an end of arm system of a robotic surface modification unit, either through the illustrated mount of FIG. 5A, or through a separate mounting system.

As illustrated in FIG. 5A, a structured light pattern 512 has a flexible backing 514 that can adjust a radius of curvature of pattern 512. It is expressly contemplated that as adjustment mechanism 514 increases or decreases a radius of curvature, angles of light sources 510 may also change as needed in response to a detected, or expected, curvature of the surface 530. It is important that rays of light emanating from light sources 512 are reflected back from surface 530 into a field of view 522 of camera 520.

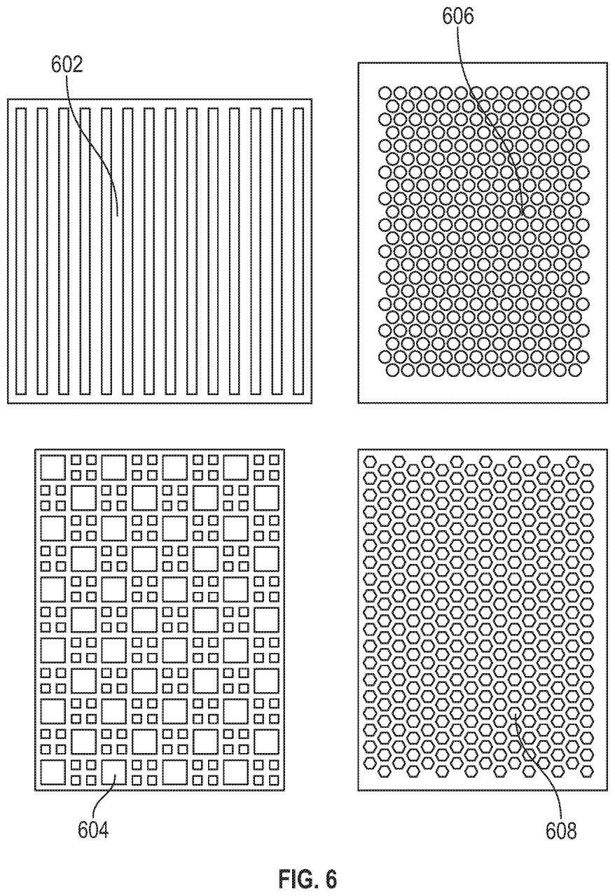

A single pattern 512 is illustrated in FIG. 5A. However, it is expressly contemplated that other patterns, for example as illustrated in FIG. 6A-6D , or any other suitable pattern, may be used in other embodiments. In the illustrated embodiment of FIG. 5A, light sources 510 are illustrated as area backlights. However, it is expressly contemplated that other suitable lighting arrangements are possible, so long as diffuse lighting is produced. For example, as described in co-filed application with Ser. No. 63/584,506, filed here with, a line light with one or more diffuser plates may also be suitable to produce diffuse lighting. High intensity lighting is illustrated herein as a line light, however it is expressly contemplated that some embodiments utilize high intensity spot lights or projectors.

FIG. 5B illustrates a different perspective view of imaging system 500. It is illustrated that light sources 510 are, in one embodiment, positioned above the camera, e.g. further away from surface 530, so that both sides of pattern 512 are illuminated. However, it is expressly contemplated that other arrangements may also be suitable. For example, the lights may be moved or adjusted based on the expected curvature. Additionally, different light sources may be used, for example a curved or dome-shaped lighting system.

It is noted that having a system with curved static structured lighting allows for system 500 to be positioned closer to a surface 530. For example, the illustrated system may be used as close as 100-500 mm away from the surface. Operating at such a close distance produces a smaller reflected field of view, providing more acceptable reflection angles to be received by camera 520. Additionally, being able to operate at such a close position also makes operation of a robotic surface modification unit easier, as being closer provides a smaller working distance, and potentially a shorter cycle time. A camera system that operates further away may take longer to move a repair tool into position after an imaging step, and may even require a larger operational cell. However, it is expressly contemplated that, for some surfaces, it may be advantageous to operate at a distance further from the surface. Systems and methods herein may accommodate either a short distance from a surface or a larger distance from a surface, depending on an application. Further, depending on a workpiece being imaged, operating at too close a distance can increase the risk of collision, or provide a field of view too small for an application

FIG. 5C illustrates one embodiment of an imaging system for a surface modification unit. Imaging system 550 is illustrated as having a camera (behind mount 570), and two light sources 560. Light sources 560 may shine light through a curved static structured light pattern. As illustrated in FIG. 5C, system 550 actually has two different static structured light patterns, pattern 562, which consists of vertical lines, pattern 564, which consists of horizontal lines. A flexible backing 566 maintains a radius of curvature of the static structured light pattern during an image capture operation. Flexible backing 566 may be adjustable, for example using any suitable method, such as rollers, slides, etc.

While two different static structured light patterns 562 and 564 are illustrated in FIG. 5C, it is expressly contemplated that one pattern may be suitable for a given image capture operation. However, in some embodiments, having more than one static structured light pattern provides benefits, as defects may be easier to see with one pattern over the other.

FIG. 6 illustrates different structured light patterns that can be used to provide structured illumination for the imaging system. In some embodiments, one or more of the grid patterns illustrated in FIG. 6 is placed over the light source(s) as a mask, and remains in place for an entire surface modification process, e.g. repair of all of the defects on a given vehicle. However, in some embodiments, a grid pattern may be removable from a light source, such that different grid patterns could be used for repair of different detected defects. In some embodiments, the pattern is incorporated into the backlight, such that it is not easily removed or exchanged in between operations.

With a fixed pattern, it is possible to obtain images at a higher rate of speed. Using only one grid pattern also allows for the entire process to be more efficient, reducing cycle time in between surface modification operations, as the analytical process is much simpler for a single grid pattern, than for a traditional complex structured light pattern.

For example, some prior art systems require a 3′×4′ high intensity display screen, through which multiple patterns are presented. While each pattern is presented, an image is taken. The images must then be analyzed and combined to provide a single surface map. Systems and methods herein can obtain the surface information necessary to conduct a surface modification sequence with a sequence of images, obtained with one grid pattern. In some embodiments, only a single image is captured. However, it may be beneficial to capture multiple images without significantly increasing cycle time.

Systems herein can be mounted to an end effector, and more easily maneuvered around a surface to obtain surface topography information. It is noted that embodiments using a single grid pattern, and obtaining a single image, results in sacrificed resolution in the Z direction (e.g. how deep the defect extends into the surface or how far it extends above the surface). However, it is only important for some embodiments, to identify a defect location, determine whether it is above or below a clearcoat layer, and estimate the height. In some embodiments the inclusion of one or more additional cameras, positioned at alternate angles/positions, could improve depth detection by using multiple cameras.

The different structured light patterns illustrated in FIG. 6 are presented as examples only, and not intended to be limiting. For example, while pattern 602 illustrates vertical lines, is expressly contemplated that horizontal or angled lines may also be used. Additionally, pattern 604 illustrates alternating sized grid patterns, however it is expressly contemplated that a single size grid pattern could also be used. Images 606 and 608 illustrate different patterns that involve circular apertures. Patterns 602-608 are provided by a patterned lighting device. However, it is expressly contemplated that other grid aperture shapes and sizes are also possible. Additionally, dynamically changing light patterns, e.g. deflectometry, single shot deflectometry, etc. may also be used.

Camera systems have a number of variables that can be adjusted to capture different information about a surface-gain, aperture and exposure time, angle of acceptance (incoming angles/vectors that can be mapped to a pixel), angular field of view, as well as numerous other settings. For example, increasing gain increases the signal to noise ratio of an image which may make haze visible on a surface. Some embodiments herein, then, may shift the gain multiple times, capturing multiple images. Comparison of the different images taken at different gains facilitates the enhancement of the measurement of haze. Haze can be a combination of signal and noise and, therefore, variation in a set of captured images taken at different gains, may help identify and quantify haze. Gain, and/or light intensity, may also be adjusted based on a color of a base coat of paint.

While other suitable light sources may be used, some systems and methods herein utilize any LED lighting systems at a range of intensities. The conditions of imaging may include a high frequency and small aperture on a camera's lens to provide a large depth of field require LEDs. High intensity LEDs may be particularly useful for specular surfaces, which do not diffuse light and reflect most light in a single direction. High intensity LEDs increase the probability of capturing defect information, given a certain exposure time, as increasing the amount of incoming light increases the amount of light captured. While, generally, exposure time increases for small apertures, a high intensity light can compensate, allowing for a reduced time needed to capture each image required. Systems and methods herein use static structured light to identify clearcoat defects, and scattered light to identify optical haze in the clearcoat.

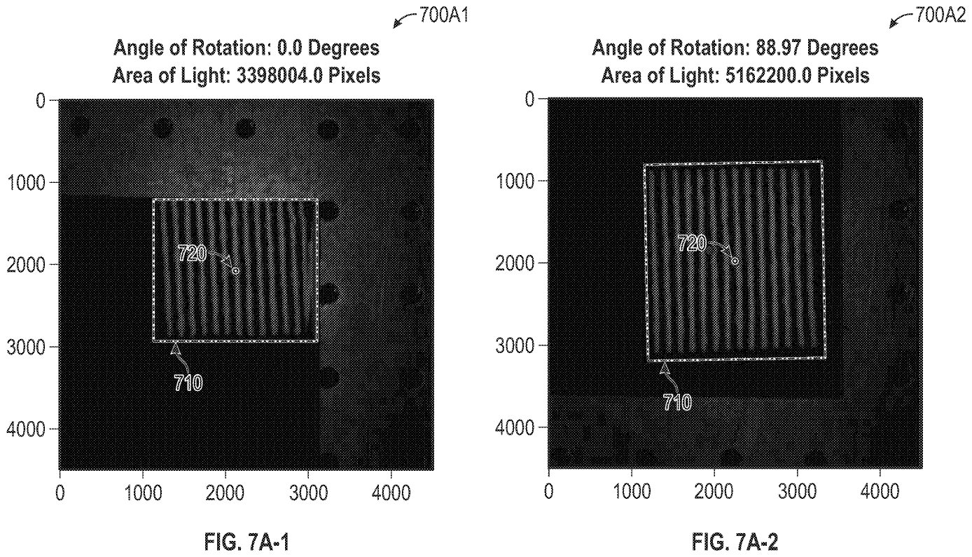

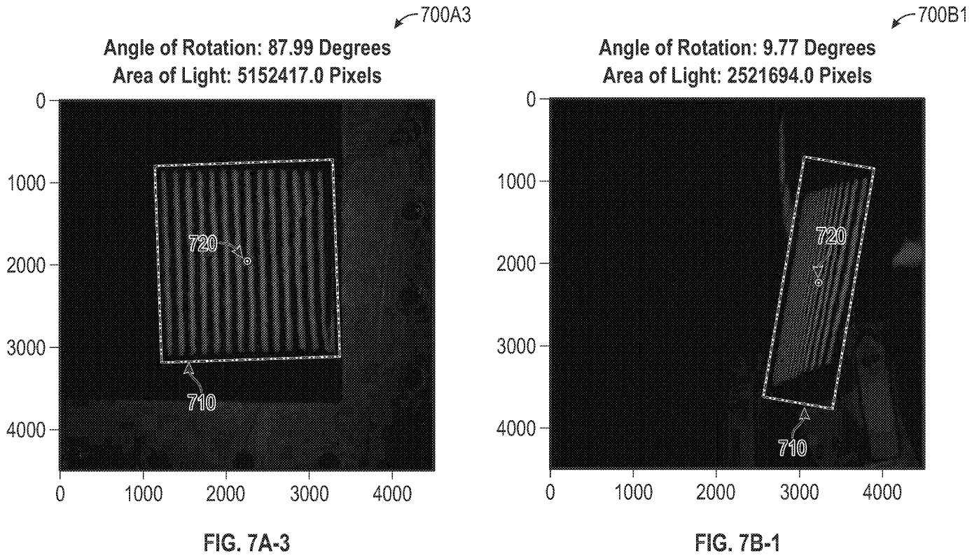

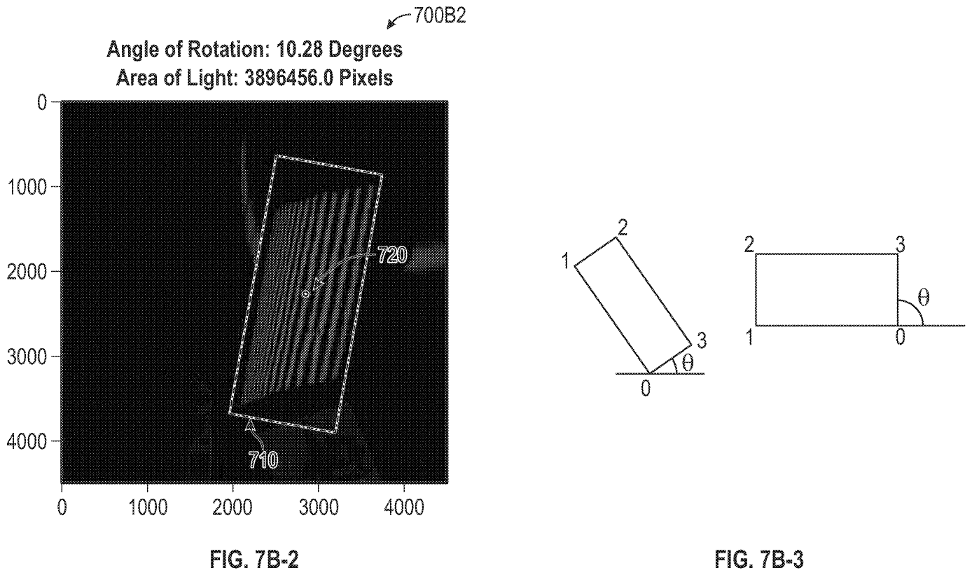

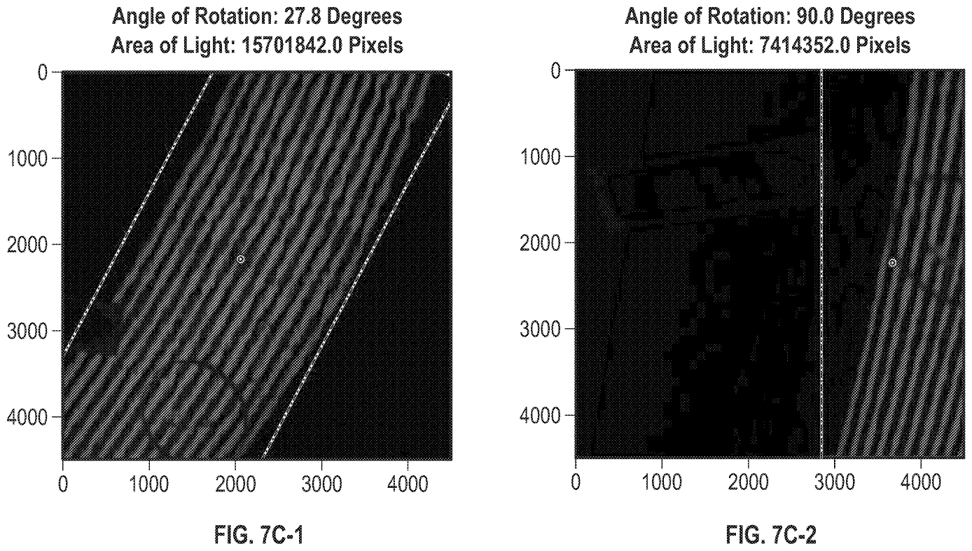

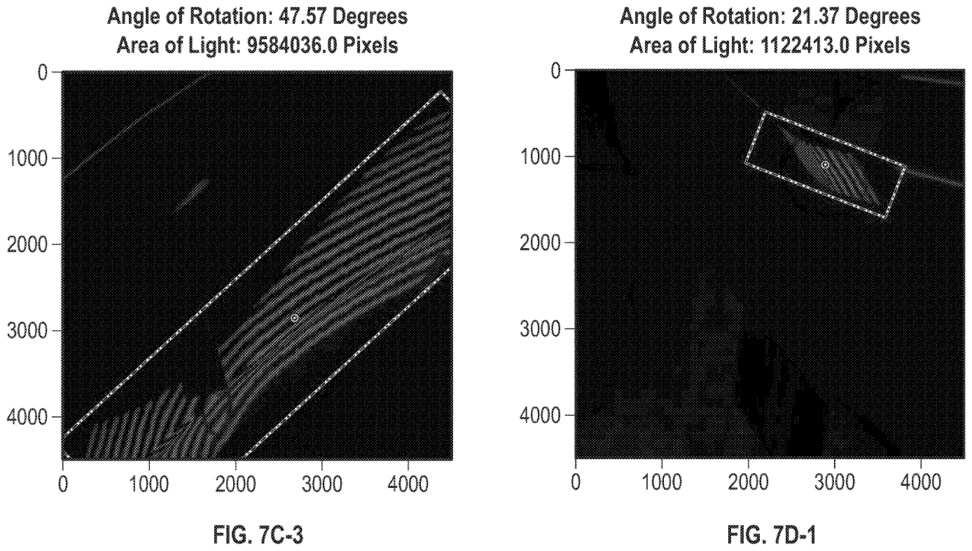

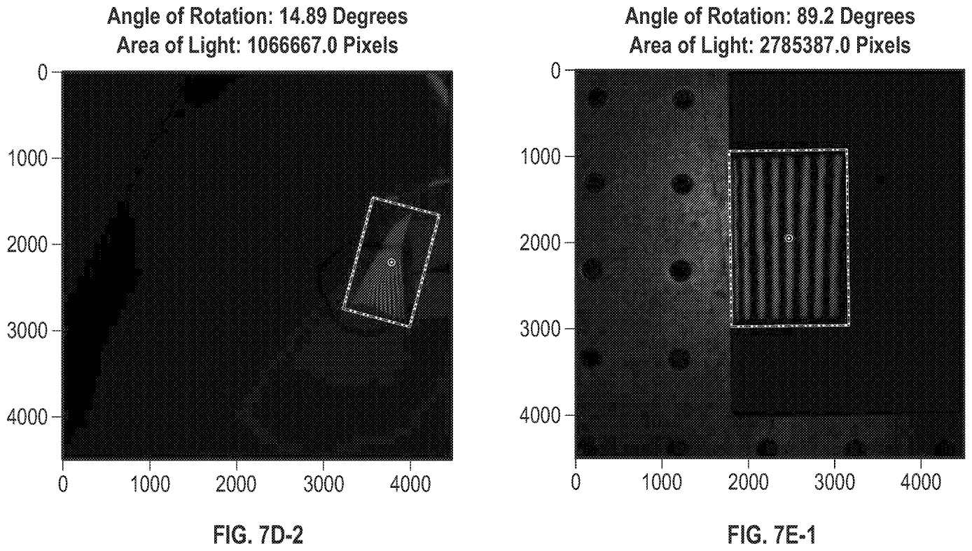

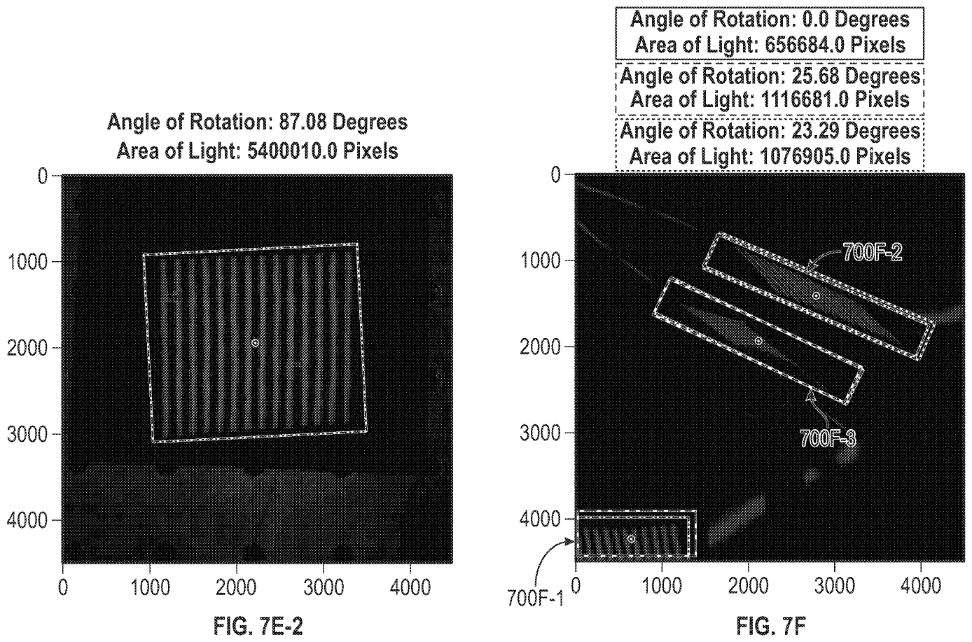

FIGS. 7A-F illustrate images of reflected gridded light on surfaces generated using systems and methods herein. Systems and methods herein may be useful for confirming whether a part is correctly positioned. While images 7A-F were captured using a flat gridded light panel, it is expressly contemplated that similar image capturing and analysis can be done using a curved lighting set up such as that described herein. For example, for a repair to a vehicle surface, the vehicle may experience jostling during a time from an initial imaging to a time of repair. Or, for a door repair, a standoff may be present between the door and the vehicle that shifts in position. Such changes could result in a repair being done to an incorrect portion of the surface, cause a collision between the repair machinery and the vehicle, etc.

While images 7A-F were captured using a flat gridded light panel, it is expressly contemplated that similar image capturing and analysis can be done using a curved lighting set up such as that described herein. FIGS. 7A-7F illustrate images of fringes on a surface. While the images of 7A-7F were captured using a flat light, it is expected that the light bars would shrink due to the morphology of the light as well as the shape of the surface being imaged. Because the light curvature is known, this can be accounted for. Projections are made with the assumption that only the surface imaged is changing. It is expected that a convex-shaped light source will cause shrinkage while a concave light will cause expansion.

Given a constant curvature, specific fringes are produced. When a surface has a region with high curvature change, reflections may be captured from several fringes, in some embodiments, or all fringes, in some embodiments.

Systems and methods herein may also be used to re-identify or relocate a defect position prior to a repair starting using an end-of-arm system. Confirming a defect is in the expected position, or identifying how the robotic repair system needs to adjust based on a new position can provide upstream information about an assembly, repair, or manufacturing system. Systems and methods herein can provide feedback about system tolerances. For example, if a defect movement is consistently within a threshold range, the tolerance is staying the same and a repair recipe and repair area size (for example selected previously during a repair process) may proceed. If instead it is seen that a tolerance is tighter than expected (e.g. a defect is within a smaller threshold range of the expected location), then the repair area may be reduced, allowing for a repair to proceed faster. If instead it is seen that a tolerance is slipping (e.g. a defect is outside the threshold range) then additional action needs to be taken to ensure that a planned repair is completed without requiring a re-repair. The additional action may involve increasing a repair area, moving positions of the repair robot, or selecting a new repair strategy.

Especially in areas of a surface where smaller repair areas are preferred, using systems and methods herein to confirm can reduce the likelihood of a re-repair needed and reduce the amount of time for repair by confirming position in-situ.

Using gridded light, images 700A1-700F of a reflective surface can be captured, as illustrated in FIGS. 7A-7F. Processing the images can result in a boundary 700 being calculated, which is a minimum area that can capture the full light bar. The images can undergo image processing to produce two outputs: (1) an angle of rotation and (2) an area of the reflected light. Boundary 700 may be defined by a center 720.

From a previous imaging, or CAD model, of a vehicle (or other surface) being repaired, the process image can be used to verify whether the field of view in a boundary 700 is as expected. Curvature on a surface causes light to reflect differently, in predictable ways.

Angles of rotation of 0, 90, 180, 270, etc. result in an upright rectangle boundary 700. Square boundaries 700 have C4 symmetry (rotations by 2π/4, e.g. 90°) and may result in indistinguishable shapes. Rectangular boundaries have C2 symmetry (rotations by 2π/2, e.g. 180°) and may result in boundary sides being aligned with “vertical” and “horizontal” axes.

FIG. 7A1-3 illustrate light reflections off of a flat panel, e.g. having no curvature. The orientation of the part with respect to the vision system can be verified by whether the angle of rotation is a member of the rectangular symmetry group (C2) In the examples, this present as +/−a threshold of 0, 90, 180, 270, etc. degrees.

Additionally, the location of a boundary 700 can be further verified with the area in view, with respect to the expected area. For example, image 700A1 has a portion of the light off the panel, thus not utilizing the entire possible field of view (FOV). This allows for feedback between the imaging system and location coordination.

An end-of-arm vision system also allows for images to be captured while the system is moving with respect to a surface. Images 700B1 and 700B2 were captured by an end of arm system in potion. Both an angle of light and the area within boundary 720 change as the system moves along a curve. With knowledge of the expected curve (e.g. from CAD files, 3D scanning or previous imaging), the captured angles/light area of the expected region can be evaluated and deviations detected.

In general, the area of a boundary 700 will expand as the vision system approaches normal orientation. The angle of the region of interest will similarly approach 0/90/180/270. In some embodiments, confirmation that a repair system is aligned with normal is done before imaging and repair of the defect.

The location can be further verified with the area of the light grid reflection visible with respect to the expected area. For example, the first image has a portion of the light off the panel, thus not utilizing the entire possible field of view (FOV). This number allows for feedback b/w the imaging system and location coordination.

FIGS. 7B-1 and 7-B2 illustrate images of reflected light on a curved surface, obtained using a gridded light. From images 700B1 and 700B2, curvature of the surface can be detected. A center point 720 for each calculated boundary 710 are illustrated. Image 700B1 illustrates an image captured at an angle of rotation of 9.77° resulting in a bounded area of 2521694.0 pixels.

The angle of rotation is calculated as illustrated in FIG. 7B-3. After the rectangular boundary is identified, the 4 corners of the bounding rectangle points are ordered clockwise starting from the point with the highest y as shown below. If 2 points have the same highest y, then the rightmost point is the starting point. The points are numbered as 0,1,2,3 (0 -starting, 3-end). The angle between the line (joining the starting and endpoint) and the horizontal is illustrated in FIG. 7B-3.

The angle of rotation is calculated as illustrated in FIG. 7B-3, and the area of the bounding rectangle is measured. The camera position and surface curvature information being already known, a determination can be made as to whether the system is aligned to the curved region, within acceptable tolerances. If the alignment is outside the acceptable tolerances, the transformation from 7B-1 to 7B-2 is made to provide a better reflection area in the FOV of the camera.

Image 700B2 illustrates an image captured at an angle of rotation of 10.28 degrees from the surface, resulting in a bounded area of 3896456.0 pixels. Images 700B1 and 700B2 may be two images captured at different times in an image captured sequence. The observed change in boundary area and pattern of reflected light can be compared to that expected for a known surface. If the observed change does not match what is expected, then the imaging system is not in the expected location. For example, if the area is smaller than expected, this indicates higher convex-surface curvature than expected, while if the grid is only partially reflected, and instead lies off-screen, this might indicate that the alignment angle of the system is off.

Similarly, by observing the change in boundary area and pattern of reflected light, the curvature, or topography, of the imaged surface can be determined, such that it is possible to compare what is seen to, for example, a CAD model of the entire surface, to identify what position on the surface is being imaged.

FIGS. 7C-1 through 7C-3 illustrate an example of a concavity on a surface. An optical cone (also referred to as a viewing cone in some domains), with the cone start at the sensor and expanding downward, includes all rays of light that are received by the sensor (e.g. camera in some cases). The optical cone expands as the optical axis extends toward the surface being imaged, and continues to diverge when looking at the origins of those reflections. For a flat surface, with the camera and light placed at specular angles, a uniform squared reflection region is expected. As curvature of a surface increases, the number of reflected rays at the camera sensor increases or decreases, changing the shape of the reflected region. With this information, we can deduce the concavity and convexity of the look at region. The optical cone expands at a greater rate if the surface has convex curvature, resulting in a smaller reflection. The optical cone expands at a slower rate if the surface has concave curvature, resulting in a larger reflection.

Concave shapes cause the light to expand, and can have varying angles. If the area for the light in the region of interest is greater than the maximum area on a flat surface, a concave surface is indicated. FIG. 7C-1 illustrates an image captured at an angle of rotation of 27.8° and resulted in an observed boundary of 15701842.0 pixels. FIG. 7C-2 illustrates an image of the same surface captured at an angle of rotation of 90.0°, resulting in an observed boundary area of 7414352.0. FIG. 7C-3 illustrates an image of the same surface captured at an angle of 47.57°, resulting in an observed boundary of 9584036.0 pixels. As illustrated in FIGS. 7C-1 to 7C-3, which are all images of the same area, with small transformations (rotation, translation, etc.), the same surface results in different resulting images, with different centroid positions of the bounding rectangle, based on the light rays reflected to the camera.

FIG. 7D-1 and FIG. 7D-2 illustrate an example of a surface with convex curvature. Convex curvature causes light to contract, resulting in light in a region of interest to be smaller than a maximum area of the light region of interest on a flat surface, and typically at an angle that is not close to 0/90/180/270°. FIG. 7D-1 illustrates an image captured at an angle of rotation of 21.4° and an observed boundary area of 1122413.0 pixels. FIG. 7D-2 illustrates an image captured at an angle of rotation of 14.9° and an observed boundary area of 1066667.0 pixels.

FIGS. 7E-1 and 7E-2 illustrate images of a surface when the imaging system is approximately at normal. Flat, or substantially flat shapes will have an angle of rotation near to 0/90/180/270 and an observed area at or below the maximum light region of interest. FIG. 7E-1 illustrates an image of a surface captured close to 0/90/180/270.

The orientation of the part with respect to the vision system can be verified by whether the angle of rotation is a member of the rectangular symmetry group (C2) In the examples of FIGS. 7A-E, this present as +/−a threshold of 0, 90, 180, 270, etc. degrees.

FIG. 7F illustrates a scenario where, due to the geometry of the surface being imaged, multiple light regions of interest may be displayed in a single image. The angle can help identify relative curvature within the 2D image of FIG. 7F. Light region of interest 700F-1, having an angle of 0° is approximately normal to the vision system, and can be estimated as a flat surface. Light regions of interest 700F-2 and 700F-3 have an angle of rotation not close to 0/90/180/270, so there likely greater relative curvature in this portion of the part. When compared to a 3D rendering, CAD model or other topography of a surface, a position of the imaging system can be validated.

FIGS. 5A-5B illustrated embodiments having a light source offset from a camera. However, it is expressly contemplated that other configurations are possible. Some currently available systems rely on a projection system, which requires a high-cost screen (e.g. LCD/LED) having high lumens, to project an adjustable reflection on a surface. Such systems also can require multiple cameras, and result in a computationally expensive analysis of the reflections—e.g. image stitching requirements, etc. Embodiments herein can achieve similar analysis with smaller light panels and fewer cameras. End-of-arm systems described herein have greater maneuverability, enabling a smaller relevant field of view, which reduces computational analysis as well.

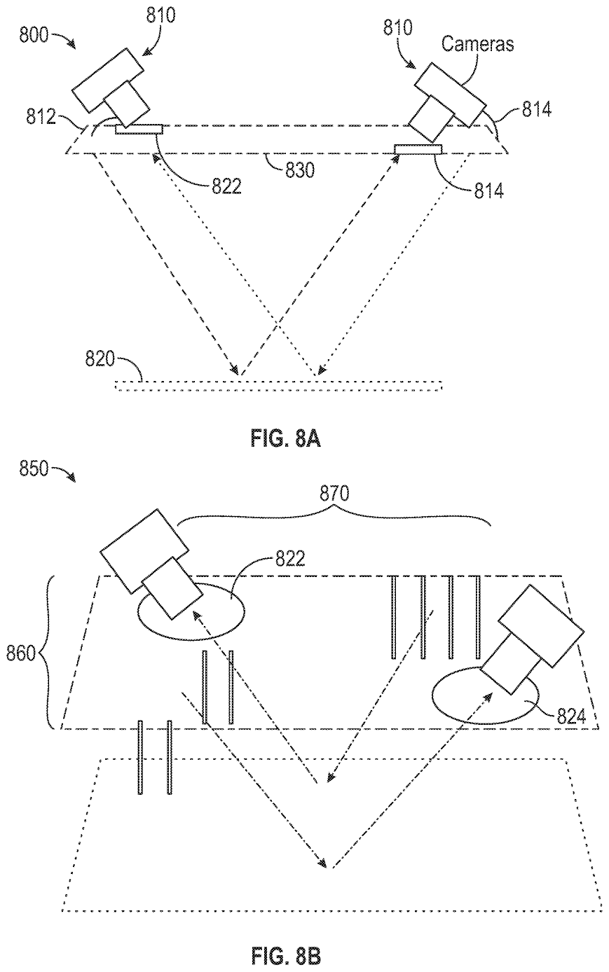

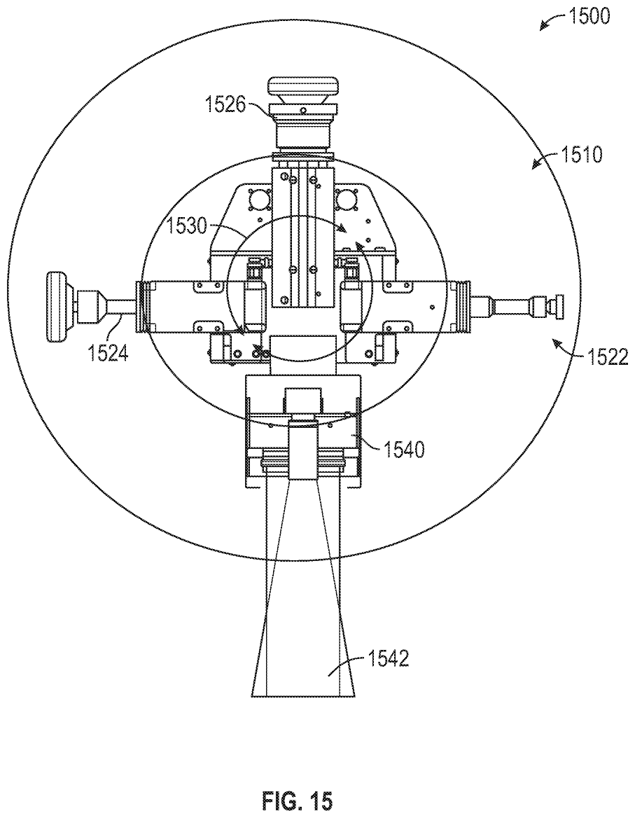

Systems illustrated in FIGS. 8-11 enable a smaller mechanical ‘footprint’ for an end of arm system because additional space is not needed for the light panel as cameras, instead, capture images through the light panel. Embodiments illustrated in FIGS. 15-18 also enable positioning of cameras at more acute angles from normal (with respect to the surface being imaged), which also reduces an overall system length. Systems and methods herein may also take advantage of specialized lenses, such as folded optics or thinner lens stacks to reduce an overall length, width and height of an end-of-arm vision system. Each of the embodiments presented and discussed in FIGS. 8-11 benefit from a reduction in space needed for an end-of-arm vision system.

FIGS. 8A and 8B illustrate a schematic of a surface imaging system 800 in accordance with embodiments herein. Imaging system 800 includes at least two cameras 810 that image a specular surface 820 through a light panel 830. Light panel 830 may be a gridded light panel, or another suitable light system. Each camera may be angled with respect to surface 820, as illustrated by angles 812 and 814. Angles 812 and 814 may be similar, or even identical, in some embodiments. Each camera images surface 820 through an area, e.g. areas 822, 824 of light panel 830. Areas 822, 824 may include apertures extending partway, or completely through, light source 830. FIG. 8A illustrates a side view of system 800. FIG. 8B illustrates a dimetric view 850 of system 800, illustrating relative placement of cameras 810. Cameras are placed apart from one another, for example along a length 870 and a width 860 of light source 830. In some embodiments, cameras 810 are placed in opposing corners of a panel light 830. System 800 is designed to image a specular surface with a reduced likelihood of holes in the grid reflection, e.g. an increased likelihood that the panel has no areas that are not illuminated by the light 830.

The ability to reduce a volume occupied by a system 800 is limited by the dimensions of light source 830. Some applications require a larger light source, while others can use a smaller light source. Using system 800, a width of a scanned image is expanded, while ambient lighting effects are reduced. A length of a scanned image is defined as the dimension of the reflection within the primary plane. A width is defined as perpendicular to the length. For example, industry applications currently use light sources on the order of a meter squared, while systems herein can utilize much smaller light sources, on the order of centimeters. The smaller size may enable systems herein to function on an end-of-arm system with a reduced risk of collision with the surface or other robotic components.

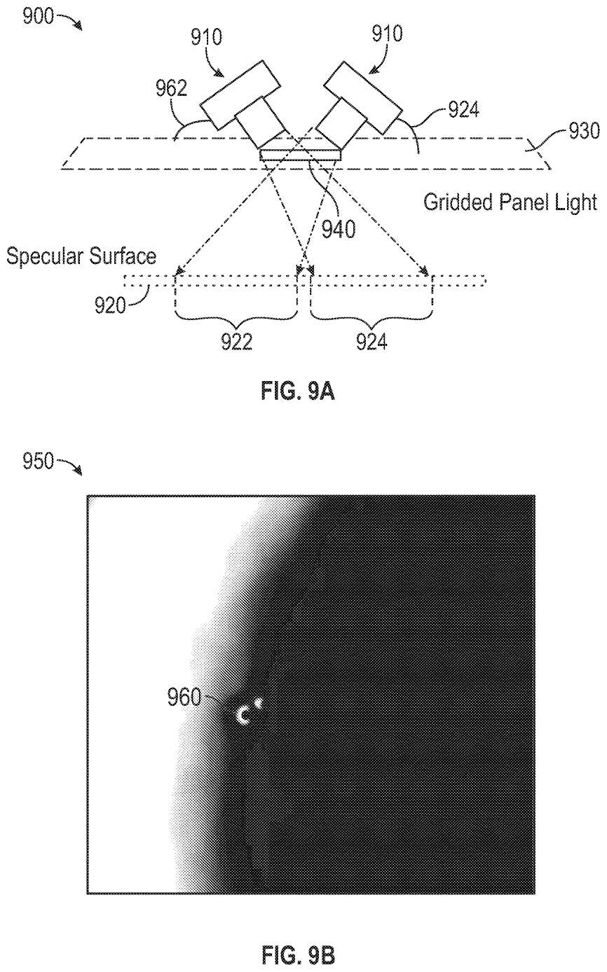

FIGS. 9A-9B illustrate a schematic of an outward facing surface imaging system in accordance with embodiments herein. System 900 includes two or more cameras 910 that image a specular surface 920 through a light panel 930. Cameras 910 are positioned, and angled, to look through an area 940 of the light panel. Cameras 910 are positioned such that they look in opposite directions. Area 940 may include, or be defined by, an aperture in light source 930. Cameras 910 are positioned such that a first field of view 922, from a camera at an angle 962, does not overlap with a second field of view 924, from a camera at an angle 962. It is noted that, while two cameras 910 are illustrated, embodiments herein also envision a four-camera arrangement, with each camera separated by about 90° from adjacent cameras.

System 900 increases an imaged reflection's physical size along the length dimension, fully utilizing the length of the light source. Because cameras 900 are not imaging the same area, an overall field of view is increased.

However, because cameras 900 are angled to increase a field of view, it is possible that an area directly underneath the viewing hole is not directly illuminated. As illustrated in FIG. 9B, this may result in a defect 960 be illuminated in an image 950 by diffuse light.

In some embodiments, a size of a field of view is reduced so that fields of view 922 and 924 overlap, or are positioned such that no, or substantially no gap, is present. In some embodiments, the light source is fully transparent. In some embodiments, the light source projects light downward, such that am image capture device is able to view downward through the light source. In some embodiments, the light source projects light downward such that no light patterns are clearly visible, such that the light would appear “clear” on the surface.

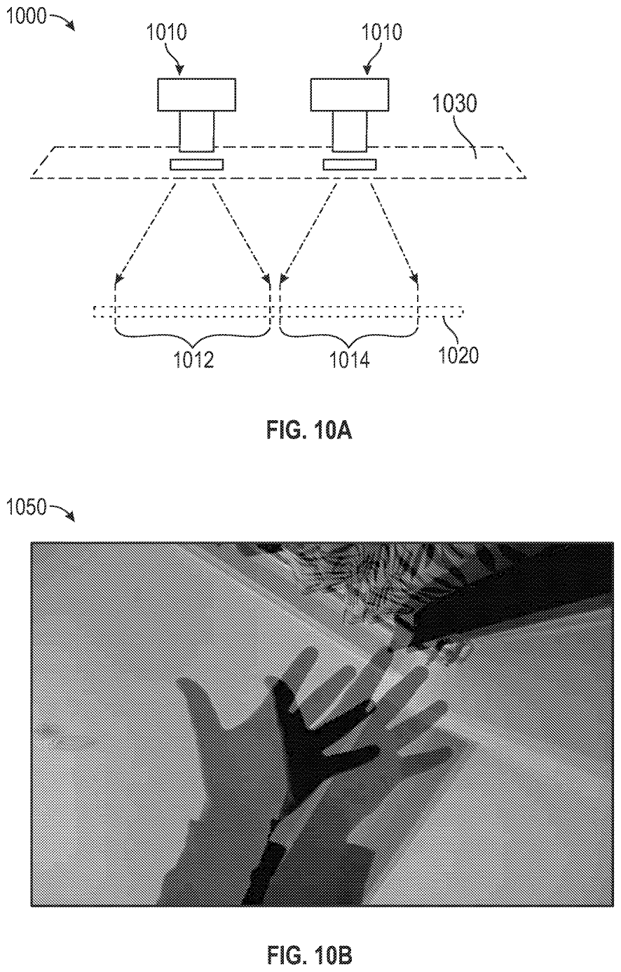

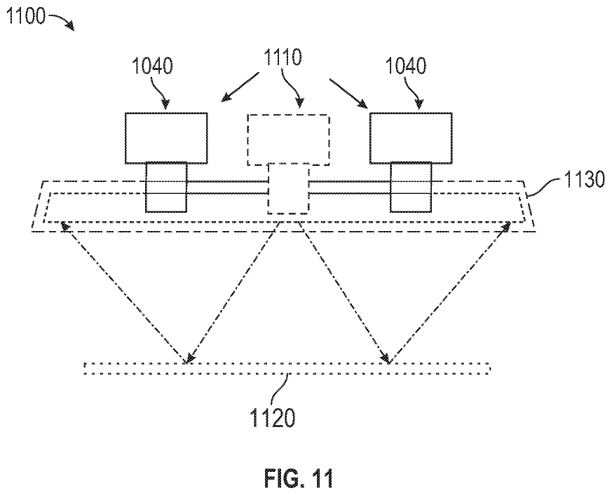

FIGS. 10A-10B illustrate a schematic of a binocular normal facing surface imaging system in accordance with embodiments herein. System 1000 operates similar to human vision, with two cameras 1010, spaced apart, each imaging a portion of surface 1020 through a light source 1030. Knowing relative positions of each camera 1010, the contrast between the two images (as illustrated by image 1050, for example) can provide depth information. Additionally, using a binocular view, images captured of surface 1020 are more likely to replicate how a surface defect would appear to a consumer. Cameras 1010 may image through light source 1030, through an aperture extending partway through, or through an aperture extending completely through light source 1030.

It is noted that, in some embodiments, cameras 1010 are placed with a straight coaxial view downward. In some embodiments, one of cameras 1010 is positioned to view surface 1020 through an aperture in the center of light source 1030.

FIG. 10B illustrates an example stereo image, computationally composed of two images captured from different places, which is useful for recovering 3D topography information.

System 1000 may, based on a distance between cameras 1010 and/or a distance between each camera 1010 and surface 1020, result in an area of surface 1020 between fields of view 1012 and 1014 that is either not imaged or not fully illuminated. However, in some embodiments, system 1000 includes a third camera 1010 e.g. such that cameras 1010 form a triangle.

FIG. 11 illustrates a schematic of a light scattering surface imaging system in accordance with embodiments herein. System 1100 utilizes directional lighting technology to illuminate surface 1120. Light source 1130 includes a panel with a plurality of light sources that send light through the panel. The light is then projected downwards toward surface 1120. Light source 1130 may be a flat dome light, which may include one or more light sources on an edge of light source 1130 (e.g. such that light is projected through the transparent panel). The panel may also include one or more features to cause light to be projected through the panel and downward to the surface. For example, a number of concave or convex surface features may be present on the panel. In some embodiments herein, light is projected downward to the surface, but is returned from the surface. For example, an LFX3-PT Series light source, available from CCS INC. may be used in some embodiments herein. Light source 1130 provides the diffuse effect of dome lights with the on-axis illumination effect of coaxial lights by using a light-guide plate with features that project light downward toward a surface, but not upward toward a camera.

FIG. 11 illustrates a system including two cameras 1140 spaced apart from each other. However, it is expressly contemplated that additional cameras, such as camera 1110, may also be added without significantly increasing a footprint of an end-of-arm system. System 1100 allows for cameras 1140 to be positioned to view surface 1120 at a position normal to surface 1120. Additionally, t he part of the surface 1120 that is not specularly illuminated may be further illuminated by a dark field illumination technique. Additionally, while the system may need to be aligned to the defect normal, camera(s) 1110 may not be in-line with the defect normal.

System 1100 provides additional flexibility in that, since permanent apertures are not required in a light source, additional cameras (e.g. camera 1110) may be added or removed without disrupting the reflected image captured by existing cameras 1140.

However, while system 1100 is illustrated using a configuration similar to that of system 1000, it is expressly contemplated that a transparent light scattering light source 1130 could be incorporated into any of systems 800, 900 or 1000, for example replacing any of light sources 830, 930, or 1030.

Systems 800-1100 may allow for decreasing a size of a specular inspection system by stacking cameras over a light source, such that cameras look through the light source. It is possible, using systems herein, to increase or maintain the size of the reflected image of the light source. While it has been discussed that some systems herein may have an area of diffuse lighting, or a hole in the reflected grid, it may be possible to reduce such interruptions by precise placement of cameras. Systems herein allow for a reduced overall size of an imaging system by rearranging the configuration of components—e.g. removing the need for placing a light source in the same plane as one or more cameras. Instead, the light source is nonplanar with the one or more cameras, such that a footprint (e.g. planar area) of the system is reduced. Stacking equipment reduces the overall volume of the system, allowing for larger effective fields of view, reduced image requirement for high curvature surfaces and, therefore, reducing inspection cycle time. Systems herein may be useful for detecting defects in a clearcoat layer of specular automobile surfaces, for example. However, it is expressly contemplated that systems herein may be useful for other specular surface imaging operations.

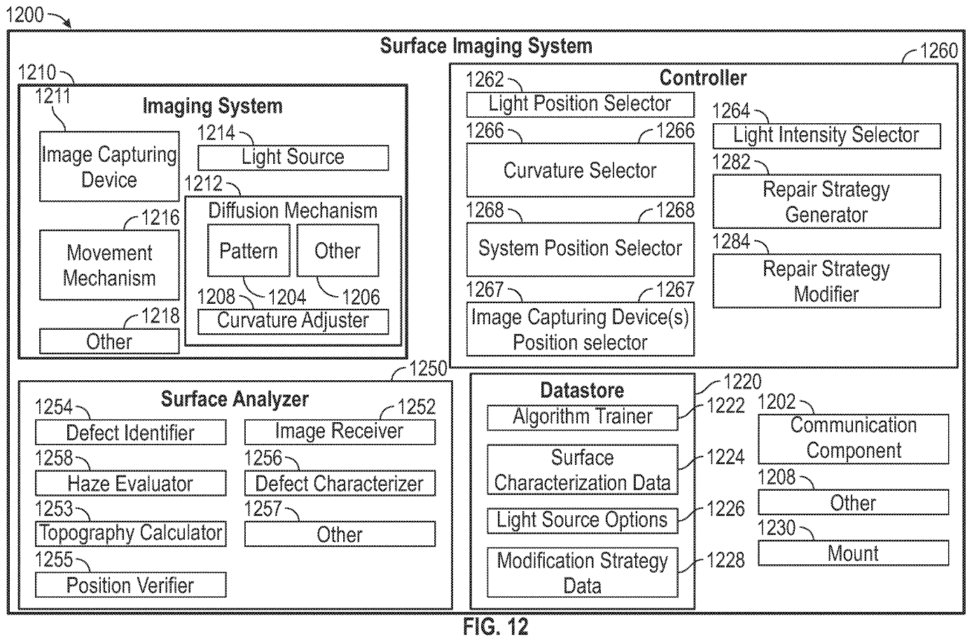

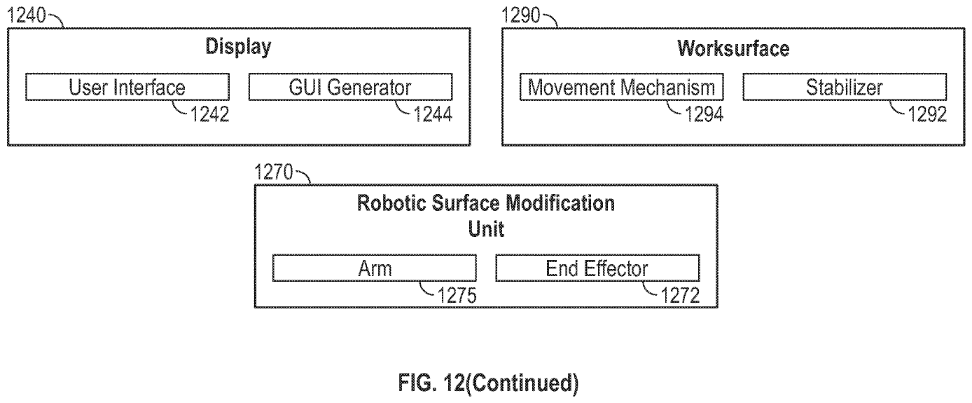

FIG. 12 illustrates a schematic of a surface imaging system. System 1200 may be designed such that it can mount, using mount 1230, to a robotic surface modification unit 1270. For example, robotic surface modification unit 1270 may include an end effector 1272 that receives mount 1230. End effector 1272 may be on an end of a robotic arm 1275.

Surface imaging system 1200 includes an imaging system 1210. Imaging system 1210 includes an image capturing device 1211, which may be a camera, a video camera, or another suitable imaging device. Imaging system 1210 may have one or more light sources 1214, for example an area backlight used for light scattering, or another suitable diffuse light source. Light source 1214, in some embodiments, is at least partially coplanar with the one or more image capturing devices 1210. However, in some embodiments, light source 1214 is not coplanar with the one or more image capturing devices 1210, such that light source 1214 is positioned in between an image capturing device 1211 and a surface 1290. In some embodiments, image capturing device 1211 images a system through light source 1214. Light source 1214 may have an aperture through with image capturing device 1211 views a surface. However, it is expressly contemplated that, in some embodiments, light source 1214 is transparent enough for image capturing device 1211 to capture images through light source 1214 without significant distortion.

It is expressly contemplated that, in some embodiments, a single light source 1214 is sufficient. Imaging system 1210 is illustrated as having a movement mechanism 1216. Movement mechanism 1916 may also, in some embodiments, be configured to move one or more image capturing devices 1911 into position with respect to each other and/or light source 1914. For example, a system 1900 may be able to change between configurations in-situ, or between surface imaging operations, e.g. while moving from a first defect site to a second defect site. System 1900 may be able to adjust a position and/or orientation of imaging devices 1910 with respect to each other, or with respect to a light source 1914.

Movement mechanism 1216 may be responsible for changing an angle of image capturing device 1210 relative to light sources 1214. Imaging system also includes a curvature adjuster, in some embodiments that adjusts a radius of curvature of light source(s) 1214 and/or of a diffusion mechanism 1212.

Diffusion mechanism 1212 may include a pattern 1204 provided between a surface and light source 1214, to provide for structured lighting of work surface 1290. However, other suitable diffusion mechanisms 1212 may be used in other embodiments.

Surface imaging system 1200 is illustrated as including a controller 1260. However, it is expressly contemplated that controller 1260 may be located elsewhere within a robotic surface modification unit 1210, for example combined into a controller for modification unit 1270, and/or, remote from either system 1200 or robotic surface modification unit 1270. Controller 1260 includes a light source selector 1262 which may select whether a first light source 1214, a second light source 1214, or both light sources be on, or off, for a particular operation. For each of the selected light source, a light intensity selector 1264 may adjust an intensity of emitted light.

Controller 1260 may also include an image capturing device position selector 1267. Movement mechanism 1216 may receive a position indication from position selector 1267, which may include a physical position and/or an orientation for one or more image capturing devices 1211.

In embodiments where a light source is moveable separate from a diffusion mechanism, a light position selector 1262 changes a relative position of one or more light sources 1214 so that rays of light are projected to worksurface 1290 through diffusion mechanism such that diffuse light is received by image capturing device 1211. Curvature selector 1266, in such embodiments, selects a radius of curvature for diffusion mechanism, which is implemented by a curvature adjuster 1208.

A system position selector 1268 selects a position of imaging system with respect to an end effector 1272.

A light intensity selector 1264 may adjust an intensity of emitted light.

Based on feedback from a surface analyzer 1250, controller 1260 may generate a repair strategy to address a detected defect, for example using repair strategy generator 1282. However, it is expressly contemplated that a repair strategy may have already been generated based on a pre-scan of the entirety of work surface 1290, in which case a repair strategy modifier 1284 may be utilized to modify the repair strategy based on information gained from surface analyzer 1250.

Surface analyzer 1250 may retrieve one or more captured images, using image receiver 1252. Surface analyzer 1250, for example powered by one or more statistical image processing and feature detection algorithms trained by algorithm trainer 1222, for example, may detect a defect on work surface 1290, using defect identifier 1254. A defect characterizer 1256 may determine other information about a detected defect using the captured images, for example: a defect type, a defect size, a defect location on work surface 1290, a defect location within a clearcoat layer on surface 1290, an estimated defect severity, or other pertinent information. If imaging system 1210 has captured images of work surface 1290 after a repair has been completed, a haze evaluator 1280 may process the images to characterize an amount of haze on the surface 1290. Surface analyzer 1250 may also have other functionality 1257. Surface analyzer 1250 may also include a position verifier 1255 which may verify a position of imaging system 1210 with respect to worksurface 1990. Images may be retrieved by image receiver 1252. From the retrieved images, topography calculator 1253 may calculate a curvature of the imaged area. Position verifier 1255 may then compare a curvature at a current position with surface characterization data 1224 to confirm whether imaging system 1210 and/or surface modification unit 1270 are correctly positioned for a surface modification operation. Calculated topographies and/or position verification information may be stored in datastore 1220. Over time, surface analyzer 1250 may monitor a drift over time-e.g. whether imaging system 1210 and/or surface modification unit 1970 are consistently in a correct position over a series of surface modification operations, drifting closer to being in a correct position, or drifting further from a correct position. Based on trends, a repair strategy generator 1282 may adjust a repair strategy to reflect a need to adjust a starting position for a repair operation.

Surface imaging system 1200 is illustrated in FIG. 12 as including a data store 1220. However, it is expressly contemplated that data store 1220 may be removed from surface imaging system 1200 and accessed, for example, using communication component 1202. Data store 1220 may include an algorithm trainer 1222 that is responsible for modifying a machine learning algorithm to improve defect characterization, by defect characterizer 1256, and/or haze quantification, for example by haze evaluator 1258. One or more algorithm trainers 1222 may also be stored in data store 1224 repair strategy generation, by repair strategy generator 1282, or repair strategy modification, by repair strategy modifier 1284. However, while supervised algorithmic techniques are possible, it is expressly contemplated that unsupervised algorithmic techniques may also be used—for example an image segmentation algorithm may be used in some embodiments herein.

Surface characterization data 1224 may also be stored in data store 1220, and may inform characterization of defects detected, and surface haze detected. Data store 1220 may also include one or more light source options 1226 that can be retrieved by controller 1260. For example, light source options 1226 may include possible angles with respect to image capturing device 1211, or between a first and second light source 1214. Data store 1220 may also include repair strategy components 1228, which may include repair strategies previously generated, and surface conditions associated with said repair strategies. Repair strategy data 1228 may be used to inform a machine learning algorithm powering repair strategy generator 1282 or repair strategy modifier 1284.

In some embodiments, surface imaging system 1200 outputs data to a display 1240, for example using a communication component 1202. Communication component 1202 may communicate with a graphical user interface generator 1244, which is illustrated as part of display 1240, but may be part of controller 1260, a remote controller, or any other suitable computing device. A generated GUI may be displayed on display 1240 using user interface 1242.

A user may interface with system 1200, for example using user interface 1242. User interface 1242 may, for example, provide access to an application that can be used to control workflow by controller 1260. Additionally, user interface 1242 may be used to display captured images, results of image processing, associated metadata related to captured images, defect characterization information, etc.

Work surface 1290 may be a specular surface with reflective characteristics in some embodiments. Work surface 1290 may move during a surface modification operation, using movement mechanism 1294. For example, a vehicle may move from a first location to a second location along an assembly line. In embodiments where a work surface 1290 is mobile, a stabilizer 1290, or a stabilizing system, may be used to maintain a relative position of for work surface 1290 with respect imaging system 1210.

Using imaging systems and methods described herein, imaging of a curved surface can be accomplished with only a few, or even only one, image capture. Systems herein increase the size of regions on curved panels that can be specularly lit up for image capture. Systems and methods herein can provide larger effective fields of view of surfaces and address the need for multiple images to characterize a highly curved surface. This can reduce cycle time.

Systems and methods herein have been described as including a flexible diffusion mechanism. An actuator may change the curvature of the flexible diffusion mechanism by flexing one or more portions. Systems and methods herein have been described as changing a radius of curvature of the flexible diffusion mechanism. It is expressly contemplated that, in some embodiments, the flexible portion can be adjusted to mirror curvature of a surface.

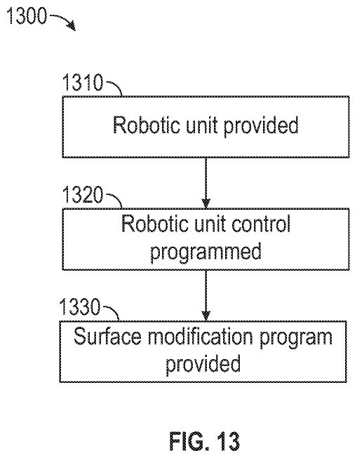

FIG. 13 illustrates a process for setting up a robotic surface modification unit. Method 800 represents the process of a purchaser of a robotic surface modification unit preparing the robot for use in a robotic cell.

In step 1310, a robotic unit is provided to a robotic cell, for example by a manufacturer of the robotic unit. The robotic unit may be provided with a controller.

In step 1320, an integrator programs a control unit so that the robotic unit can move within the robot cell as needed. Programming the robotic unit may include inputting physical constraints (e.g. cell dimensions, tool specifications attached to the robot arm, etc.), movement constraints (maximum speeds, force, etc.). When movement of the robotic surface modification unit is needed, it is this controller that sends control signals.

In step 1330, a surface modification operation is executed. For example, the surface modification may be provided from controller 1260 of FIG. 12, generated by repair strategy generator 1282.

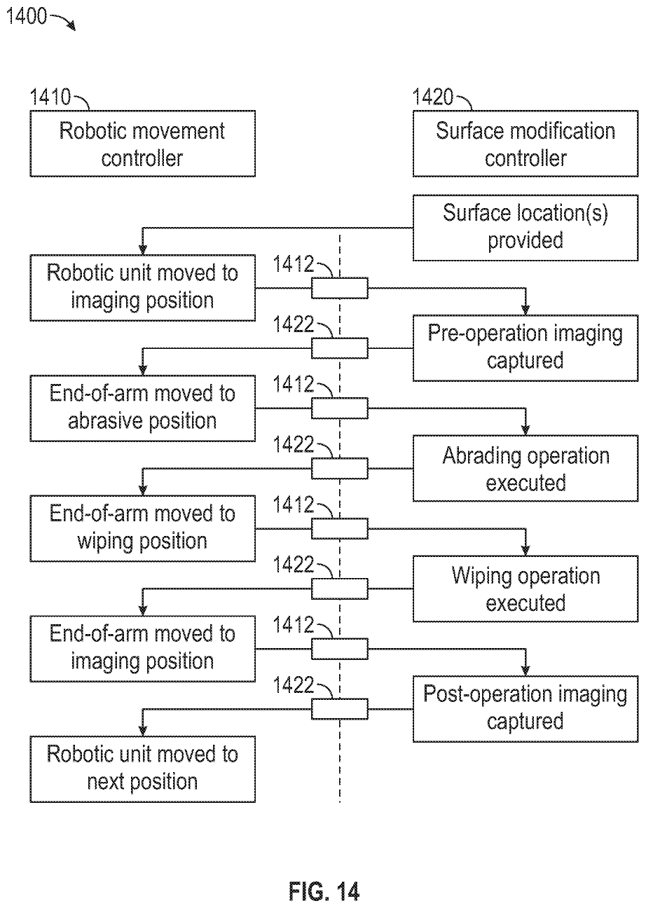

FIG. 14 illustrates an operational sequence for a surface modification operation by a robotic repair unit. Because of the different controllers involved, the process of executing a surface modification operation involves many “handshakes” that have to be executed for the operation to be a success. In implementations where the integrator-programmed control unit (e.g. controller 150) is separate from controller 1460, executing a surface modification strategy requires a 1412 from the robotic controller 1410 to surface modification controller 1420, once movement controller 1410 has moved the robotic until into position. Once the surface modification step is complete, a transfer of control 1422 back to robotic movement controller 1410 is needed. Illustrated is a simplified exemplary abrading operation on a surface-e.g. to remove material, repair a defect, smooth a worksurface, etc. As each tool (abrading, wiping) or system (imaging, fluid dispensing) is moved into or out of position with respect to a surface, movement controller 1410 needs to be engaged if a part of a robotic arm unit needs to be moved (e.g. to change a distance from an end effector to the surface). When the tool or system needs to operate, control must be handed back to surface modification controller 1420.

In some operations, surface modification controller 1420 does not actually take control, but must feed step by step operational instructions to controller 1410. E.g. every waypoint in a defect removal operation, speed/angle/force applied at each waypoint, etc.

In addition to the time taken and potential failed execution of a handshake protocol, the time needed to move a robot from an imaging position to a fluid dispensing position, to an abrading position, to a wiping position, back to an imaging position, and so on adds to the cycle time. A configuration is desired that reduces the number of handshakes needed for a surface modification operation.

FIG. 15 illustrates an end-of-arm tool configuration for a robotic surface modification unit in accordance with embodiments herein. In the illustrated embodiment, an abrading arrangement is illustrated with an imaging system and a wiping system are mounted orthogonal to a sanding tool and a polishing tool. All four tools are coplanar and are operational at a similar distance (measured from an end effector sensor) from the surface, requiring only rotation of a rotational joint and potentially a slight adjustment in the Z-direction to account for small height differences. Such a configuration simplifies a robotic surface modification unit by, in the Example of FIG. 14, allowing surface modification controller 1420 to complete a sequence of operational steps before a handshake protocol is needed to return control to robotic controller 1410.

System 1500 illustrates an end-of-arm system for surface modification that can be mounted to a robotic arm, for example instead of tools 128 and imaging system 126 in FIG. 1. An active compliance device rotates as illustrated by arrow 1530 (or counterclockwise, in some embodiments). Four tools are mounted such that they are coplanar 1510. Illustrated in FIG. 15 are a sanding tool 1522, a polishing tool 1524, a wiping system 1526, and an imaging system 1540. However, it is expressly contemplated that other tools or systems may be suitable for other surface modification operations. In some embodiments, system 1500 has one degree of freedom with closed loop-controlled force and position. In the illustrated embodiment, tools 1522, 1524, 1526 and 1540 are coplanar 1510, and arranged in pairs substantially orthogonal to each other (e.g. 1526/1540 and 1522/1524). However, other rotational distances may be suitable for other operations. System 1500 allows for end-to-end process ownership for a surface modification controller which can reduce cycle time, integration burden and path flexibility. Additionally, more path flexibility is available, allowing for more aggressive tilting motion near feature lines during a repair operation. And, since all tools are rotationally fixed to a single mount, motion between tools is collision free as the design can be represented as a column for collision prevention and detection. The column can be represented by the volume with overall tool thickness and the longest tool length as the radius. This abstracted volume representation, for a robot controller (e.g. 1410) will not collide with a surface (e.g. a vehicle body) upon motion within the robotic cell.

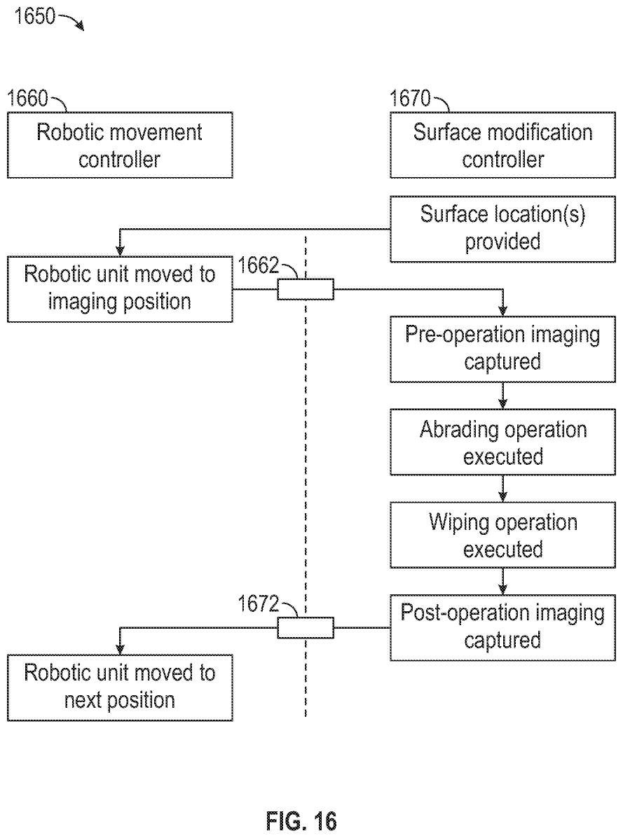

FIG. 16 illustrates an operational sequence for a surface modification operation by a robotic repair unit in some embodiments herein. Comparing sequence 1650 with sequence 1400, it is illustrated that the number of handshakes using a configuration like that of FIG. 15 can dramatically reduce the number of handshakes to as few as two-transfer 1662 of control from robotic movement controller 1660 to surface modification system 1670, and back again after the operation is finished, with transfer 1672. In some embodiments, robot controller 1670 can also execute some movement commands of the robotic arm, e.g. approaches and departures from a defect location. Such a configuration allows for the surface modification controller 1670 to control a majority of movements for a surface modification, with the robot controller mainly controlling the movement from defect area to defect area.

Systems and methods herein utilize novel lighting techniques to detect clearcoat defects on curved surfaces. Systems herein may be mounted to robotic surface modification unit in a suitable position with respect to the surface. Systems herein may be mounted with 1, 2, 3 or even more additional tools needed for a surface modification operation. The tools may be coplanar with each other.

It is important for systems and methods described herein to maintain alignment of the camera image area, the specular reflection of the static structured light, and the surface being imaged. The camera image axis may need to positioned with respect to the normal vector from the surface area of interest, such that the region of interest is visible. In other embodiments, a field of view of an image device is positioned with respect to a region of interest on a surface. However, other alignment configurations are possible.

In embodiments where a surface topography is known (e.g. from a 3D model, a previous scan, etc.) dynamic lighting may be used. The relative position of a light source, as well as the curvature of said light source may change based on the known topography. In some embodiments, a light source is configured to change from a first configuration to a second configuration based on a known or detected topography of a surface. In some embodiments, changing from the first to second configuration includes maintaining a constant working distance between the light source and the surface as either or both of the light source and surface move. In some embodiments, a light panel height relative to the surface is constant across the curvature of the surface.

For specular surfaces, the main rays of light reflect off the surface such that an angle of reflectance is equal to an angle of incidence. Because of specular reflection, the incident and reflected light are within a plane. The main axis of the camera/lens therefore should be set at the correct position and orientation such that this axis intercepts those main rays of light with accuracy. The field of view needs to be in line with the normal vector from the surface area of interest, e.g. the area containing a defect. It may also be important to maintain stability of an imaging system such that the alignment remains correct.

Defects may be best detected using a specular lighting system. Defects may have some three dimensionality (e.g. defect size, shape and/or location within a Z-axis of clearcoat layers), so it is important to see the shadowing effect of a defect within the layer of clearcoat. A specular lighting set up may consist of the light source and the camera being tilted so that the reflected light is received by the camera.

It is expressly contemplated that lighting setups, including selected angles for a light source (or sources), curvature of a structured light pattern, light intensity, etc. may all be selected at least in part based on the pre-scan of the surface.

Surface inspection systems have been described herein that include image capturing devices, such as a camera, one or more light sources, distant sensors, etc. Systems and methods herein describe components for managing and executing capture of said images, and processing said images to obtain defect characterization information, and surface characterization information. Systems and methods herein have been described that can store and retrieve captured images, image metadata, defect detection and characterization results, and manipulate said information to generate or improve a repair strategy. Systems described herein are expressly contemplated to be interoperable with a controller of a robot arm to which they are mounted, and may in fact be controllable by said robot controller. Additionally, systems herein are contemplated to be interoperable with other system components of a robotic system.

Systems and methods herein enable coordination of machine vision equipment, image capture using efficient and highly mobile illumination conditions, and identification of surface characteristics and defects on specular surfaces.

However, it is expressly contemplated that systems and methods herein may be useful for other industries, for example while it is envisioned that the vehicle and use cases described herein are being repaired at an initial manufacturing site, it is also contemplated that an automotive aftermarket use case is also relevant. Additionally, recurring or constant evaluations of internal or external processes such as part repairs, evaluating metallic and/or paint finishes for other groups of products, or even high spatial resolution mapping of an environment using a mobile robot.

Further, it is contemplated that a surface imaging system herein may be useful for other specular surfaces, for example imaging a surface pre-and post-adhesive application, for example.

FIG. 16 is a block diagram of a surface modification architecture. The remote server architecture 1600 illustrates one embodiment of an implementation of a surface modification system 1610. As an example, architecture 1600 can provide computation, software, data access, and storage services that do not require end-user knowledge of the physical location or configuration of the system that delivers the services. In various embodiments, remote servers can deliver the services over a wide area network, such as the internet, using appropriate protocols. For instance, remote servers can deliver applications over a wide area network and they can be accessed through a web browser or any other computing component. Software or components shown or described in FIGS. 1-16 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

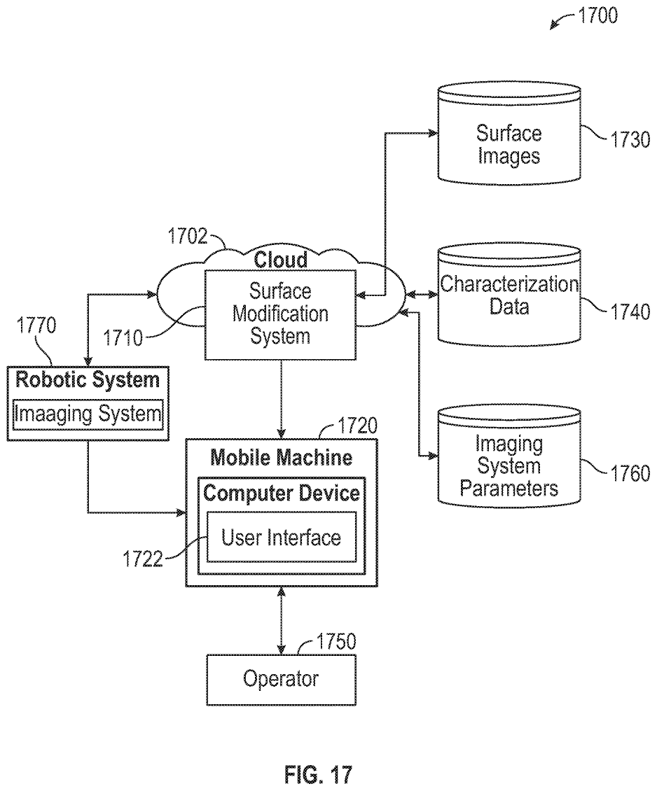

In the example shown in FIG. 17, some items are similar to those shown in earlier figures. FIG. 17 specifically shows that a surface modification system can be located at a remote server location 1702. Therefore, computing device 1720 accesses those systems through remote server location 1702. Operator 1750 can use computing device 1720 to access user interfaces 1722 as well.

FIG. 17 also depicts another example of a remote server architecture. FIG. 17 shows that it is also contemplated that some elements of systems described herein are disposed at remote server location 1702 while others are not. By way of example, storage 1730, 1740 or 1760 or other systems 1770 can be disposed at a location separate from location 1702 and accessed through the remote server at location 1702. Regardless of where they are located, they can be accessed directly by computing device 1720, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

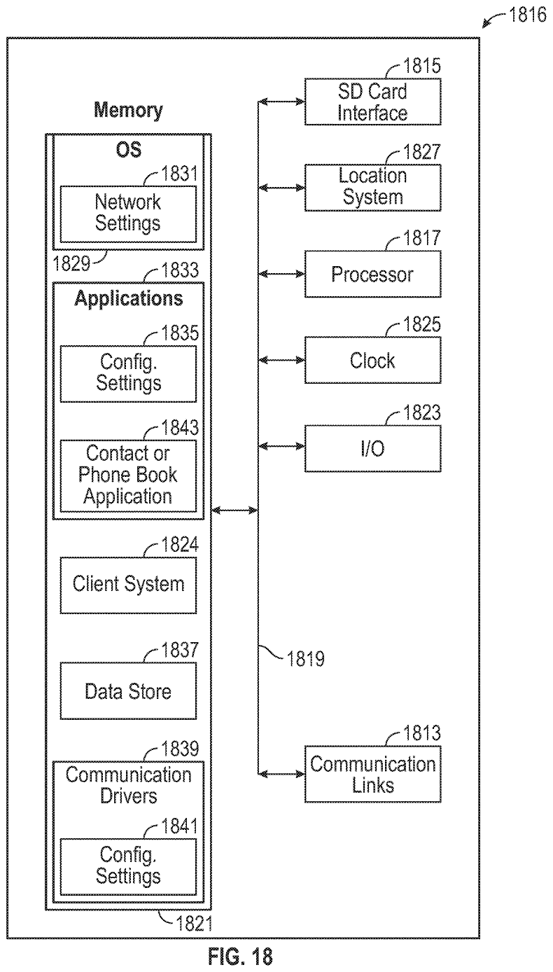

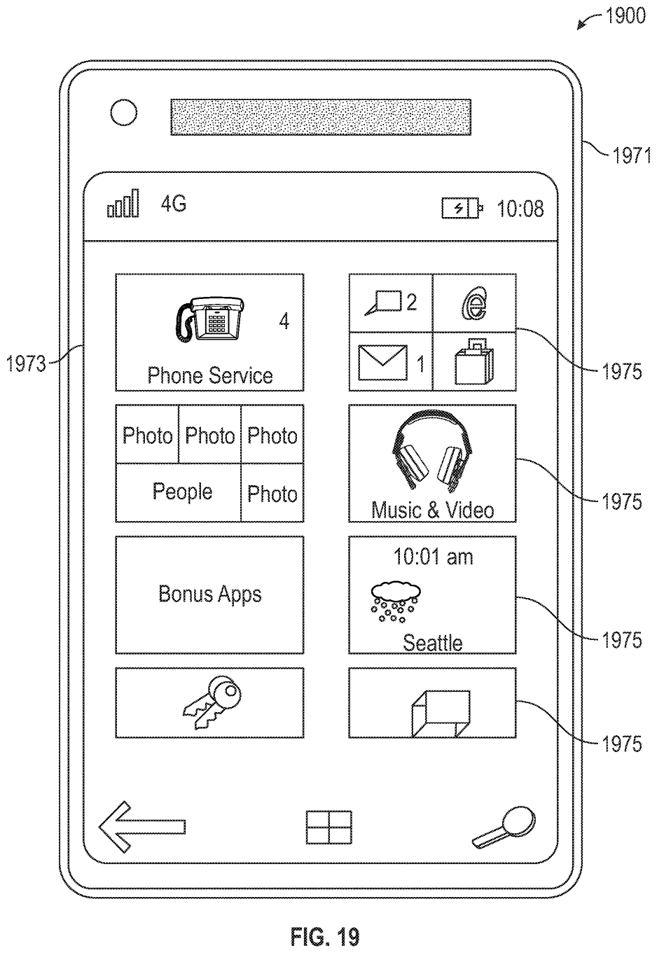

FIGS. 18-19 show examples of mobile devices that can be used in the embodiments shown in previous Figures.

FIG. 18 is a simplified block diagram of one illustrative example of a handheld or mobile computing device that can be used as a user's or client's handheld device 1816 (e.g., as computing device 1720 in FIG. 17), in which the present system (or parts of it) can be deployed. For instance, a mobile device can be deployed in the operator compartment of computing device 1820 for use in generating, processing, or displaying the data. FIG. 19 is another example of a handheld or mobile device.

FIG. 18 provides a general block diagram of the components of a client device 1816 that can run some components shown and described herein. Client device 1816 interacts with them, or runs some and interacts with some. In the device 1816, a communications link 1813 is provided that allows the handheld device to communicate with other computing devices and under some embodiments provides a channel for receiving information automatically, such as by scanning. Examples of communications link 1813 include allowing communication though one or more communication protocols, such as wireless services used to provide cellular access to a network, as well as protocols that provide local wireless connections to networks.

In other examples, applications can be received on a removable Secure Digital (SD) card that is connected to an interface 1815. Interface 1815 and communication links 1813 communicate with a processor 1817 (which can also embody a processor) along a bus 1819 that is also connected to memory 1821 and input/output (I/O) components 1823, as well as clock 1825 and location system 1827.

I/O components 1823, in one embodiment, are provided to facilitate input and output operations and the device 1816 can include input components such as buttons, touch sensors, optical sensors, microphones, touch screens, proximity sensors, accelerometers, orientation sensors and output components such as a display device, a speaker, and or a printer port. Other I/O components 1823 can be used as well.

Clock 1825 illustratively comprises a real time clock component that outputs a time and date. It can also provide timing functions for processor 1817.

Illustratively, location system 1837 includes a component that outputs a current geographical location of device 1816. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 1821 stores operating system 1829, network settings 1831, applications 1833, application configuration settings 1835, data store 1837, communication drivers 1839, and communication configuration settings 1841. Memory 1821 can include all types of tangible volatile and non-volatile computer-readable memory devices. It can also include computer storage media (described below). Memory 1821 stores computer readable instructions that, when executed by processor 1817, cause the processor to perform computer-implemented steps or functions according to the instructions. Processor 1817 can be activated by other components to facilitate their functionality as well.

FIG. 19 shows that the device can be a smart phone 1971. Smart phone 1971 has a touch sensitive display 1973 that displays icons or tiles or other user input mechanisms 1975. Mechanisms 1975 can be used by a user to run applications, make calls, perform data transfer operations, etc. In general, smart phone 1971 is built on a mobile operating system and offers more advanced computing capability and connectivity than a feature phone.

Note that other forms of the devices 1916 are possible.

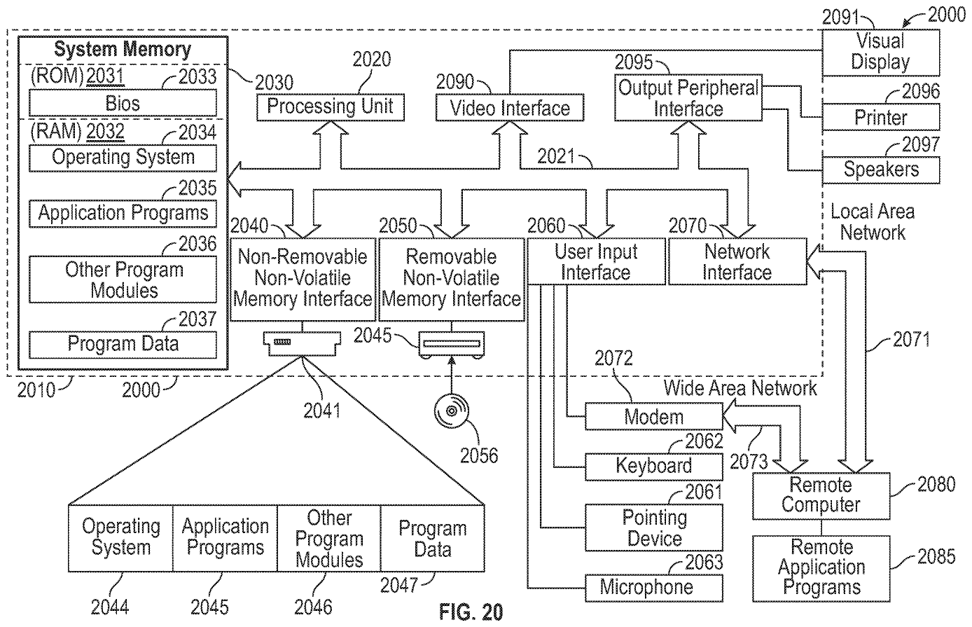

FIG. 20 is a block diagram of a computing environment that can be used in embodiments shown in previous Figures.

FIG. 20 is one example of a computing environment in which elements of systems and methods described herein, or parts of them (for example), can be deployed. With reference to FIG. 20, an example system for implementing some embodiments includes a general-purpose computing device in the form of a computer 2010. Components of computer 2010 may include, but are not limited to, a processing unit 2020 (which can comprise a processor), a system memory 2030, and a system bus 2021 that couples various system components including the system memory to the processing unit 2020. The system bus 2021 may be any of several types of bus structures including a memory bus or memory controller, a peripheral bus, and a local bus using any of a variety of bus architectures. Memory and programs described with respect to systems and methods described herein can be deployed in corresponding portions of FIG. 20.

Computer 2010 typically includes a variety of computer readable media. Computer readable media can be any available media that can be accessed by computer 2010 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 2010. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 2030 includes computer storage media in the form of volatile and/or nonvolatile memory such as read only memory (ROM) 2031 and random access memory (RAM) 2032. A basic input/output system 2033 (BIOS) containing the basic routines that help to transfer information between elements within computer 2010, such as during start-up, is typically stored in ROM 2031. RAM 2032 typically contains data and/or program modules that are immediately accessible to and/or presently being operated on by processing unit 2020. By way of example, and not limitation, FIG. 20 illustrates operating system 2034, application programs 2035, other program modules 2036, and program data 2037.

The computer 2010 may also include other removable/non-removable and volatile/nonvolatile computer storage media. By way of example only, FIG. 20 illustrates a hard disk drive 2041 that reads from or writes to non-removable, nonvolatile magnetic media, nonvolatile magnetic disk 2052, an optical disk drive 2055, and nonvolatile optical disk 2056. The hard disk drive 2041 is typically connected to the system bus 2021 through a non-removable memory interface such as interface 2040, and optical disk drive 2055 are typically connected to the system bus 2021 by a removable memory interface, such as interface 2050.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 18, provide storage of computer readable instructions, data structures, program modules and other data for the computer 2010. In FIG. 20, for example, hard disk drive 2041 is illustrated as storing operating system 2044, application programs 2045, other program modules 2046, and program data 2057. Note that these components can either be the same as or different from operating system 2034, application programs 2035, other program modules 2036, and program data 2037.

A user may enter commands and information into the computer 2010 through input devices such as a keyboard 2062, a microphone 2063, and a pointing device 2061, such as a mouse, trackball or touch pad. Other input devices (not shown) may include a joystick, game pad, satellite receiver, scanner, or the like. These and other input devices are often connected to the processing unit 2020 through a user input interface 2060 that is coupled to the system bus, but may be connected by other interface and bus structures. A visual display 2091 or other type of display device is also connected to the system bus 2021 via an interface, such as a video interface 2050. In addition to the monitor, computers may also include other peripheral output devices such as speakers 2097 and printer 2096, which may be connected through an output peripheral interface 2095.

The computer 2010 is operated in a networked environment using logical connections, such as a Local Area Network (LAN) or Wide Area Network (WAN) to one or more remote computers, such as a remote computer 2080.

When used in a LAN networking environment, the computer 2010 is connected to the LAN 2071 through a network interface or adapter 2070. When used in a WAN networking environment, the computer 2010 typically includes a modem 2072 or other means for establishing communications over the WAN 2073, such as the Internet. In a networked environment, program modules may be stored in a remote memory storage device. FIG. 20 illustrates, for example, that remote application programs 2085 can reside on remote computer 2080.

1. An imaging system for a reflective surface comprising:
a light source;
an imaging device positioned to capture images of the reflective surface;
a static structured light pattern, produced by the light source, configured to adjust from a first curved configuration to a second curved configuration, wherein the first curved configuration comprises a different shape than the second curved configuration;
wherein the light source is positioned such that the static structured light pattern is produced on the reflective surface and is reflected from the reflective surface into a field of view of the imaging device.

2. (canceled)

3. The imaging system of claim 1, wherein the first curved configuration comprises a first radius of curvature, the second curved configuration comprises a second radius of curvature, and wherein the first radius of curvature is different from a second radius of curvature.

4. The imaging system of claim 1, and further comprising:
a curvature adjustment mechanism that adjusts the status structured light pattern from the first curved configuration to the second curved configuration.

5. The imaging system of claim 1, and further comprising a light source modifier that modifies a position, an angle or an intensity of the light source.

6. The imaging system of claim 1, wherein the second curved configuration has a system curvature is similar to a curvature of the reflective surface.

7-9. (canceled)

10. The imaging system of claim 1, and further comprising a movement mechanism that is configured to change a position or orientation of the imaging device.

11. (canceled)

12. A robotic surface modification system comprising:
a robotic arm;
an active compliance unit coupled to the robotic arm;
an end effector coupled to the active compliance unit;
an imaging system mounted to the end effector, wherein the imaging system is configured to capture images of a curved, specular surface, wherein the imaging system comprise a light source, the light source comprising curvature.

13. The system of claim 12, wherein a surface modification tool is mounted to the end effector, and wherein the surface modification tool comprises a sanding tool, a polishing tool or a wiping tool.

14-16. (canceled)

17. The system of claim 12, and further comprising:
a surface modification controller configured to actuate the imaging system, in an imaging system operation, and to actuate a surface modification tool, in a surface modification operation.

18. The system of claim 12, wherein the surface modification tool is coplanar with the imaging system such that the surface modification tool can actuate rotation of a joint of the robotic arm to move the imaging system from alignment with the active compliance unit, and the surface modification tool into alignment with the active compliance unit.

19. (canceled)

20. (canceled)

21. The system of claim 12, wherein the light source comprises a structured light pattern.

22. (canceled)

23. The system of claim 21, wherein the structured light pattern is provided on a flexible backing that is adjustable from a first shape to a second shape, and wherein the first shape and second shape are different.

24. (canceled)

25. (canceled)

26. The system of claim 25, and further comprising:
a position verification system comprising:
a topography retriever that retrieves a known topography of the surface; and
a position verifier that compares the detected curvature to the known topography.

27. The system of claim 26, wherein, based on a detection that the known topography differs from the detected topography, a surface modification trajectory is updated.

28. The system of claim 27, wherein updating the surface modification trajectory comprises:
changing a starting point;
increasing a surface modification area;
decreasing a surface modification area; or
selecting a different trajectory.

29-31. (canceled)

32. A method of modifying a surface, the method comprising:
imaging the surface, a first time, using an imaging system mounted to an end-of arm system of a robotic surface modification unit;
characterizing the surface, based on images captured by the imaging system;
switching a relative position of the imaging system with a tool of the surface modification system;
based on the characterization, conducting a surface modification operation, using the tool;
imaging the surface, using the imaging system, a second time; and
evaluating the surface modification operation based on the second captured images.

33. The method of claim 32, wherein the imaging system comprises a light source and a structured light pattern, and wherein the structured light pattern is curved.

34. The method of claim 33, wherein the structured light pattern has a backing material, and wherein the backing material is configured to adjust from a first shape to a second shape, wherein the second shape comprises a higher radius of curvature than the first shape, wherein the light source is configured to adjust from a first arrangement to a second arrangement based on the adjustment from the first shape to the second shape.

35. The method of claim 32, wherein the imaging system and the tool are both mounted to an end effector of the robotic surface modification unit and wherein switching a relative position comprises rotating a joint of the robotic surface modification unit.

36-40. (canceled)
